(19) United States
(12) Patent Application Publication
(10) Pub. No.: US 2010/0079602 A1
(43) Pub. Date: Apr. 1, 2010

(54) METHOD AND APPARATUS FOR ALIGNMENT OF AN OPTICAL ASSEMBLY WITH AN IMAGE SENSOR

(75) Inventors: Jonathon Leigh Napper, Balmain (AU); Zhenya Alexander Yourlo, Balmain (AU); Colin Andrew Porter, Balmain (AU); Matthew John Underwood, Balmain (AU); Robert John Brice, Balmain (AU); Zsolt Szarka-Kovacs, Balmain (AU); Paul Lapstun, Balmain (AU)

Correspondence Address: SILVERBROOK RESEARCH PTY LTD, 393 DARLING STREET, BALMAIN, 2041, AU

(73) Assignee: Silverbrook Research Pty Ltd.

(21) Appl. No.: 12/566,634

(22) Filed: Sep. 24, 2009

Related U.S. Application Data
(60) Provisional application No. 61/100,266, filed on Sep. 26, 2008.

(51) Int. Cl. H04N 5/228

(52) U.S. Cl. 348/208.1; 348/E05.031

(57) ABSTRACT

A method is described for positioning an image sensor at a point of best focus for a lens. The lens has an optical axis and the image sensor is moved to a plurality of positions along the optical axis. The image sensor captures an image of a target image at each of the plurality of positions through the lens. A measure of blur in the image captured is derived at each of the plurality of positions from pixel data output from the image sensor. A relationship is derived between blur and position of the image sensor along the optical axis. The image sensor is then moved to a position on the optical axis that the relationship indicates as the point of best focus where the image sensor is fixedly secured relative to the lens.

### FIELD OF THE INVENTION

The present invention relates to the assembly of optical components on to an image sensor. In particular, the invention relates to the precisely locating the image sensor at the point of best focus relative to the lens of a fixed focus image sensor.

### BACKGROUND OF THE INVENTION

Digital cameras such as those in cell phones use an infinite focus setting. The lens and the image sensor (that is, charge coupled device (CCD) array) are positioned relative to each other on the assumption that light rays from the object being imaged, are parallel when incident on the lens. Parallel incident light corresponds to the object being at an infinite distance from the lens. In reality, this is not the case but a good approximation for objects more than about 2 m from the lens. Incident light from the object is not parallel, but very close to parallel and the resulting image focused on the image sensor is adequately sharp. At object distances more than a few meters, the level of blur in the image is usually too small for the resolution of the image sensor array to detect.

Many digital cameras have an auto focus function that detects blur and minimizes it by moving the lens. This permits close ups of objects down to about 10 cm from the lens. However, some digital imaging systems need to image objects close to the lens without the aid of auto focus.

Electronic image sensing pens manufactured under license from Anoto, Inc. (see U.S. Pat. No. 7,832,361) require short focus camera modules. These camera modules have a fixed focal plane because operating an autofocus capability would be impractical. Unfortunately, the objects that the pen needs to image are not always at the focal plane. In this case the objects are the coded data pattern positioned on the media substrate. Pen grip varies from user to user and pen grip also varies during use by a single user. In light of this, the images captured will usually have a significant level of blur. The image processor is capable of handling blur below a certain threshold. In light of this, the image sensor needs to be positioned relative to the lens so that the level of blur in images captured through the specified pose range of the pen, remains below the threshold. This is achieved by relying on precise manufacturing tolerances. High precision components and assembly drive up production costs.

### CROSS REFERENCES

The following patents or patent applications filed by the applicant or assignee of the present invention are hereby incorporated by cross-reference.

| | | | | |
|---|---|---|---|---|
| 11/123,136 | 10/944,043 | 11/124,256 | 10/409,864 | 10/778,090 |
| 11/782,596 | 11/041,649 | 11863255 | 11863273 | 11/041,556 |
| 11/041,723 | 11/041,698 | 10/815,609 | 10/815,610 | 10/913,374 |
| 10/913,379 | 12114805 | 09/693,690 | 10/291,481 | 10/291,821 |
| 11/107,941 | 11/491,225 | 11/839,542 | 10/983,029 | 11/107,817 |
| 10/917,466 | 11/144,840 | 11970951 | 10/893,372 | 10/492,161 |
| 11/936,638 | 09/575,172 | 10/291,546 | 10/815,638 | 10/815,618 |
| 12/047,321 | 11/488,162 | 11/488,163 | 11/488,164 | 11/488,167 |
| 11/488,168 | 11/488,165 | 11/488,166 | 12043851 | 12117624 |
| 12143811 | 12169616 | 12169617 | 1,216,919 | 12169620 |
| 12169622 | 10/815,636 | 11/863,257 | 11863258 | 11863262 |
| 12177833 | 11/041,626 | 11/041,624 | 11863269 | 11863271 |
| 12056260 | 12056254 | 11/041,580 | 11/041,648 | 11863263 |
| 11845672 | 11/482,986 | 11/482,985 | 11/454,899 | 11/583,942 |
| 11/592,990 | 11849360 | 11/831,961 | 11/831,962 | 11/831,963 |
| 12119497 | 11/832,629 | 11/832,637 | 61027756 | 12055316 |
| 12171295 | 12188209 | 61078319 | 11/756,625 | 11/756,626 |
| 11/756,628 | 11/756,629 | 11/756,631 | 12121790 | 12144593 |
| 10/685,583 | 10/685,584 | 11/020,106 | 11/020,260 | 11/020,321 |
| 11/020,319 | 11/082,815 | 11/202,252 | 11/222,977 | 11/520,170 |
| 11/706,964 | 11/739,032 | 11/830,849 | 11/866,394 | 11/934,077 |
| 11951874 | 12015487 | 12023860 | 12023005 | 12036266 |
| 12/047,311 | 12/047,276 | 12101125 | 12050927 | 12102013 |
| 12101061 | 12116922 | 12106971 | 12106963 | 12139494 |
| 12140180 | 12141039 | 12171297 | 12170435 | 12177145 |
| 12190588 | 11/203,205 | 11/653,219 | 11/706,309 | 12050161 |
| 12143824 | 12144581 | 12143825 | 12178610 | 12178613 |
| 12178615 | 12178617 | 12178620 | 12178621 | 12178623 |
| 12170405 | 12178637 | 12178639 | 12178640 | 12178625 |
| 12178627 | 12178628 | 12178630 | 12178632 | 12178633 |
| 12178635 | 61085897 | 11/155,557 | 11/193,481 | 11/193,435 |
| 11/193,482 | 11/193,479 | 11/488,832 | 11/495,814 | 11/495,823 |
| 11/495,822 | 11/495,820 | 11/653,242 | 11/829,936 | 11/839,494 |
| 11866336 | 12036264 | 12105204 | 12100403 | 12100405 |
| 12100407 | 12100408 | 12138342 | 12139490 | 61074977 |
| 12178638 | 11/842,948 | 12025746 | 12025747 | 12025748 |
| 12025749 | 12025750 | 12025751 | 12025754 | 12025756 |
| 12025757 | 12025759 | 12025760 | 12025761 | 12025762 |
| 12025764 | 12025765 | 12025766 | 12025767 | 12025768 |
| 12114803 | 12178611 | 12178612 | 12178616 | 12140225 |
| 12178619 | 12178622 | 12178624 | 12178626 | 12178629 |
| 12178631 | 10/510,392 | 11/944,404 | 11/102,843 | 11/753,570 |
| 11/865,711 | 12054194 | 12/049,376 | 12/049,377 | 12/049,379 |
| 12/049,987 | 12/050,005 | 12/050,014 | 12/050,054 | 12/050,067 |
| 12/050,080 | 12106326 | 12036904 | 12102004 | 12102005 |
| 12102006 | 12102007 | 12102010 | 12102011 | 12121787 |
| NPX097US | 11856061 | 11856062 | 11856064 | 11856066 |
| 11/672,950 | 11/672,947 | 11/672,891 | 11/672,954 | 11/672,533 |
| 11754310 | 11/754,321 | 11/754,320 | 11/754,319 | 11/754,318 |
| 11/754,317 | 11/754,316 | 11/754,315 | 11/754,314 | 11/754,313 |
| 11/754,312 | 11/754,311 | 12015507 | 12015508 | 12015509 |
| 12015510 | 12015511 | 12015512 | 12015513 | 12178641 |
| 12178642 | 11/743,657 | 12169551 | 12205903 | 12199714 |
| 12199718 | 12234687 | 12212628 | 12212629 | 12212630 |
| 12212631 | 12212632 | 12235585 | 12235588 | 12235593 |
| 12199738 | 12210986 | 12204684 | 12234683 | 12178618 |
| 12178634 | 12178636 | 12234685 | 12178614 | 12202296 |
| 12202384 | 12050101 | 10/815,621 | 10/815,630 | 10/815,642 |
| 10/815,635 | 10/815,617 | 10/815,614 | 11/041,627 | 11863268 |
| 11863270 | 11/084,796 | 10/291,555 | 11/154,676 | 11/182,002 |
| 11/329,187 | 11/830,848 | 10/965,933 | 11/866,387 | 10/778,058 |
| 10/778,060 | 10/778,062 | 10/778,061 | 10/778,057 | 10/919,379 |
| 11/495,821 | 11866313 | 10/510,391 | 12031615 | 12102751 |
| 11/737,094 | 12/050,025 | 12121783 | 7,243,835 | 7,251,050 |
| 7,097,094 | 7,137,549 | 7,156,292 | 7,427,015 | 7,357,323 |
| 7,137,566 | 7,131,596 | 7,128,265 | 7,207,485 | 7,197,374 |
| 7,175,089 | 7,178,719 | 7,207,483 | 7,296,737 | 7,270,266 |
| 7,314,181 | 7,267,273 | 7,383,991 | 7,383,984 | 7,128,270 |
| 7,395,963 | 7,150,398 | 7,159,777 | 7,188,769 | 7,097,106 |
| 7,070,110 | 7,243,849 | 7,314,177 | 7,204,941 | 7,282,164 |
| 7,278,727 | 7,417,141 | 7,367,665 | 7,138,391 | 7,153,956 |
| 7,423,145 | 7,122,076 | 7,148,345 | 7,376,273 | 7,400,769 |
| 7,156,289 | 7,178,718 | 7,225,979 | 7,380,712 | 7,079,712 |
| 6,825,945 | 7,330,974 | 6,813,039 | 7,190,474 | 6,987,506 |
| 6,824,044 | 7,038,797 | 6,980,318 | 6,816,274 | 7,102,772 |
| 7,350,236 | 6,681,045 | 6,678,499 | 6,679,420 | 6,963,845 |
| 6,976,220 | 6,728,000 | 7,110,126 | 7,173,722 | 6,976,035 |
| 6,813,558 | 6,766,942 | 6,965,454 | 6,995,859 | 7,088,459 |
| 6,720,985 | 7,286,113 | 6,922,779 | 6,978,019 | 6,847,883 |
| 7,131,058 | 7,295,839 | 7,406,445 | 6,959,298 | 6,973,450 |
| 7,150,404 | 6,965,882 | 7,233,924 | 7,175,079 | 7,162,259 |
| 6,718,061 | 7,012,710 | 6,825,956 | 7,222,098 | 7,263,508 |
| 7,031,010 | 6,972,864 | 6,862,105 | 7,009,738 | 6,989,911 |
| 6,982,807 | 6,829,387 | 6,714,678 | 6,644,545 | 6,609,653 |
| 6,651,879 | 7,293,240 | 7,415,668 | 7,044,363 | 7,004,390 |
| 6,867,880 | 7,034,953 | 6,987,581 | 7,216,224 | 7,162,269 |
| 7,162,222 | 7,290,210 | 7,293,233 | 7,293,234 | 6,850,931 |
| 6,865,570 | 6,847,961 | 7,162,442 | 7,159,784 | 7,404,144 |
| 6,889,896 | 7,174,056 | 6,996,274 | 7,162,088 | 7,388,985 |
| 7,417,759 | 7,362,463 | 7,259,884 | 7,167,270 | 7,388,685 |
| 6,986,459 | 7,181,448 | 7,324,989 | 7,231,293 | 7,174,329 |
| 7,369,261 | 7,295,922 | 7,200,591 | 7,347,357 | 7,382,482 |
| 7,389,423 | 7,401,227 | 6,991,153 | 6,991,154 | 7,322,524 |
| 7,408,670 | 7,327,485 | 7,428,070 | 7,225,402 | 7,271,931 |
| 7,430,058 | 7,421,337 | 7,336,389 | 7,068,382 | 7,007,851 |
| 6,957,921 | 6,457,883 | 7,044,381 | 7,094,910 | 7,091,344 |
| 7,122,685 | 7,038,066 | 7,099,019 | 7,062,651 | 6,789,194 |
| 6,789,191 | 7,278,018 | 7,360,089 | 6,644,642 | 6,502,614 |
| 6,622,999 | 6,669,385 | 6,827,116 | 7,011,128 | 7,416,009 |
| 6,549,935 | 6,987,573 | 6,727,996 | 6,591,884 | 6,439,706 |
| 6,760,119 | 7,295,332 | 7,064,851 | 6,826,547 | 6,290,349 |
| 6,428,155 | 6,785,016 | 6,831,682 | 6,741,871 | 6,927,871 |
| 6,980,306 | 6,965,439 | 6,840,606 | 7,036,918 | 6,977,746 |
| 6,970,264 | 7,068,389 | 7,093,991 | 7,190,491 | 7,177,054 |
| 7,364,282 | 7,180,609 | 7,292,363 | 7,414,741 | 7,202,959 |
| 6,982,798 | 6,870,966 | 6,822,639 | 6,474,888 | 6,627,870 |
| 6,724,374 | 6,788,982 | 7,263,270 | 6,788,293 | 6,946,672 |
| 6,737,591 | 7,091,960 | 7,369,265 | 6,792,165 | 7,105,753 |
| 6,795,593 | 6,980,704 | 6,768,821 | 7,132,612 | 7,041,916 |
| 6,797,895 | 7,015,901 | 7,289,882 | 7,148,644 | 7,096,199 |
| 7,286,887 | 7,400,937 | 7,324,859 | 7,218,978 | 7,245,294 |
| 7,277,085 | 7,187,370 | 7,019,319 | 7,043,096 | 7,148,499 |
| 7,336,267 | 7,388,221 | 7,245,760 | 7,358,697 | 7,055,739 |
| 7,233,320 | 6,830,196 | 6,832,717 | 7,182,247 | 7,120,853 |
| 7,082,562 | 6,843,420 | 6,789,731 | 7,057,608 | 6,766,944 |
| 6,766,945 | 7,289,103 | 7,412,651 | 7,299,969 | 7,264,173 |
| 7,108,192 | 7,111,791 | 7,077,333 | 6,983,878 | 7,134,598 |
| 6,929,186 | 6,994,264 | 7,017,826 | 7,014,123 | 7,134,601 |
| 7,150,396 | 7,017,823 | 7,025,276 | 7,284,701 | 7,080,780 |
| 7,376,884 | 7,334,739 | 7,380,727 | 7,359,551 | 7,308,148 |
| 6,957,768 | 7,170,499 | 7,106,888 | 7,123,239 | 6,982,701 |
| 6,982,703 | 7,227,527 | 6,786,397 | 6,947,027 | 6,975,299 |
| 7,139,431 | 7,048,178 | 7,118,025 | 6,839,053 | 7,015,900 |
| 7,010,147 | 7,133,557 | 6,914,593 | 6,938,826 | 7,278,566 |
| 7,123,245 | 6,992,662 | 7,190,346 | 7,417,629 | 7,382,354 |
| 7,221,781 | 7,213,756 | 7,362,314 | 7,180,507 | 7,263,225 |
| 7,287,688 | 6,454,482 | 6,808,330 | 6,527,365 | 6,474,773 |
| 6,550,997 | 7,093,923 | 6,957,923 | 7,131,724 | 7,396,177 |
| 7,168,867 | 7,125,098 | 7,396,178 | 7,413,363 | 7,249,901 |
| 7,188,930 | 10/815,637 | 10/815,634 | 10/815,620 | 10/815,613 |
| 11/944,449 | 11/041,650 | 11/041,651 | 11/041,652 | 11/041,610 |
| 11863253 | 11/041,609 | 11863264 | 11/863,265 | 11/863,266 |
| 11/863,267 | 11/480,957 | 11/764,694 | 11957470 | 10/815,628 |
| 10/913,376 | 11/172,816 | 11/172,815 | 11/172,814 | 11/482,990 |
| 11/756,630 | 11/084,742 | 11/084,806 | 09/575,197 | 09/575,181 |
| 09/722,174 | 10/291,523 | 10/291,471 | 10/291,825 | 10/291,576 |
| 10/291,592 | 10/685,523 | 10/804,034 | 10/831,232 | 10/954,170 |
| 10/981,626 | 10/981,616 | 11/026,045 | 11/051,032 | 11/107,944 |
| 11/082,940 | 11/202,251 | 11/202,253 | 11/202,218 | 11/206,778 |
| 11/203,424 | 11/286,334 | 11/349,143 | 11/491,121 | 11/442,428 |
| 11/454,902 | 11/442,385 | 11/478,590 | 10/900,129 | 10/982,975 |
| 11/331,109 | 10/901,154 | 10/932,044 | 10/962,412 | 10/965,733 |
| 10/974,742 | 10/982,974 | 10/986,375 | 11/149,160 | 11/206,756 |
| 11/730,392 | 10/778,056 | 10/778,059 | 10/778,063 | 10/917,436 |
| 10/943,856 | 10/943,878 | 10/943,849 | 11/155,556 | 11/298,474 |
| 11866305 | 11866324 | 11866348 | 11866359 | 10/291,718 |
| 10/537,159 | 10/786,631 | 10/971,146 | 12015477 | 10/492,169 |
| 10/492,152 | 10/502,575 | 10/531,229 | 10/531,733 | 10/683,040 |
| 11/074,782 | 11/075,917 | 11/672,522 | | |

The disclosures of these co-pending applications are incorporated herein by reference.

### SUMMARY OF THE INVENTION

According to a first aspect, the present invention provides a method of positioning an image sensor at a point of best focus for a lens with an optical axis, the method comprising the steps of:

moving the image sensor to a plurality of positions along the optical axis;

using the image sensor to capture an image of a target image at each of the plurality of positions through the lens;

deriving a measure of blur in the image captured at each of the plurality of positions from pixel data output from the image sensor;

deriving a relationship between blur and position of the image sensor along the optical axis;

moving the image sensor to a position on the optical axis that the relationship indicates as the point of best focus; and,

fixedly securing the image sensor relative to the lens.

This technique derives the level of blur as a function of displacement along the optical axis for each individual lens and image sensor. This relaxes the imperative for the lens, and the optical barrel in which it is mounted, to have precise tolerances because manufacturing inaccuracies in the individual components do not affect the positioning of the sensor relative to the lens.

Preferably, the step of deriving a measure of blur in the image captured by the image sensor at each of the plurality of positions involves deriving the proportion of high frequency content in the target image as a measure of blur.

Preferably, the proportion of high frequency content is estimated by summation of frequency component amplitudes sensed by the image sensor above a frequency threshold.

Preferably, distributions of frequency component amplitudes from the captured images are determined, and the entropy of the distribution is determined and used as a measure the proportion of high frequency content for each of the captured images.

Preferably, the proportion of high frequency content is determined by performing a fast Fourier transform on a selection of pixels from the image sensor and calculating a magnitude of the frequency content of the selection.

Preferably, the selection is a window of pixels from the image sensor, the pixels being in an array of rows and columns, and the fast Fourier transform of each row and column is combined into a 1-dimensional spectrum.

Preferably, the proportion of high frequency content is determined by performing a discrete cosine transform on a selection of pixels from the image sensor and calculating a magnitude of the frequency content of the selection.

Preferably, the step of deriving a measure of blur in the image captured by the image sensor at each of the plurality of positions involves using spatial-domain gradient information from pixels sensed by the image sensor to estimate sharpness of any edges.

Preferably, the spatial-domain gradient information is the second derivative of pixel values from the captured images.

Preferably, the second derivatives are determined by convolving the pixels of the captured images using a Laplacian kernel.

Preferably, the step of deriving a measure of blur in the image captured by the image sensor at each of the plurality of positions involves generating a pixel value distribution by compiling a histogram of pixels values from pixels sensed by the image sensor and calculating the standard deviation of the pixel value distribution such that higher standard deviations indicate better focus.

Preferably, the method further comprises the step of applying an interpolating function to the measures of blur derived for each of the plurality of positions.

Preferably, the interpolating function is a polynomial and a maximum value of the polynomial is determined by finding the roots of the derivative of the polynomial function.

Preferably, the target image has frequency content that does not vary with scale as the image sensor is moved along the optical axis.

Preferably, the target image is a uniform noise pattern.

Preferably, the uniform noise pattern is a binary white noise pattern.

Preferably, the target image is a pattern of segments radiating from a central point.

Preferably, the lens is mounted in an optical barrel and the image sensor is fixedly secured to the optical barrel. Preferably, the image sensor is fixedly secured using a UV curable adhesive. Preferably, the image sensor has a planar exterior surface and the method further comprises the step of adjusting the image sensor tilt prior to fixedly securing the image sensor relative the lens.

Preferably, the step of moving the image sensor along the optical axis involves indexing the image sensor along regularly spaced points on the optical axis. Preferably, the regularly spaced points are less than 1 mm apart. Preferably, the image sensor is indexed along a section of the optical axis that spans the position of best focus.

Preferably, the method further comprises the step of uniformly illuminating the target image.

Preferably, the method further comprises the step of applying an interpolating function to the measures of blur derived for each of the plurality of positions. Preferably, the interpolating function is a polynomial and a maximum value of the polynomial is determined by finding the roots of the derivative of the polynomial function.

Preferably, the method further comprises the step of measuring the blur from the image sensor at the position best focus indicated by the relationship and, comparing the measure of blur at the position of best focus to the measures of blur at each of the plurality of positions to confirm the position best focus has the least blur.

According to a second aspect, the present invention provides a method for positioning optical components that have an optical axis, relative to an image sensor, the method comprising:

providing a target depicting an image of uniform noise;

positioning the optical components relative to the image sensor such that the image sensor and the target are on the optical axis;

capturing a set of images of the target at a plurality of positions along the optical axis, the plurality of positions spanning from one side of the optical components focal plane to the other side of the optical components focal plane;

determining a measure of the level of blur in each image of the set of images from an analysis of the broadband frequency content of each of the images captured;

deriving a relationship between the level of blur and position along the optical axis; and,

determining a position of best focus to a point on the optical axis at which the relationship indicates that the broadband frequency content of a captured image has the highest proportion of high frequency components.

According to a third aspect, the present invention provides an apparatus for optical alignment of an image sensor at a position of best focus relative to a lens having an optical axis, the apparatus comprising:

a sensor stage for mounting the image sensor;

an optics stage for mounting the lens;

a target mount for a target image;

a securing device for fixedly securing the lens and the image sensor at the position of best focus; and,

a processor for receiving images captured by the image sensor; wherein,

the sensor stage and the optical stage are configured for displacement relative to each other such that the image sensor is moved to a plurality of positions along the optical axis, the image sensor capturing images of the target through the lens at each of the plurality of positions and the processor is configured to provide a measure of the proportion of high frequency components in the captured images to find the portion of best focus where the measure is a maximum.

### BRIEF DESCRIPTION OF THE DRAWINGS

The invention will now be described by way of example only with reference to the accompanying drawings in which:

FIG. 1 is a side perspective of the Netpage pen;

FIG. 2 is a nib end perspective of the Netpage pen;

FIG. 3 is a diagram of the Netpage system;

FIG. 4 is a perspective view of the Netpage pen docked in a Netpage cradle;

FIG. 5 is a cross-sectional front view of the Netpage pen;

FIG. 6 is a perspective view showing cradle contacts on the Netpage pen;

FIGS. 7A to 7D show schematically various charging and data connection options for the Netpage pen and Netpage cradle;

FIG. 8 is an exploded view of the pen;

FIG. 9 is a longitudinal section of the pen;

FIG. 10 is an exploded view of an optical assembly for the pen;

FIG. 11 is a cutaway perspective of the optical assembly;

FIG. 12 is an interconnect diagram for a main PCB of the pen;

FIGS. 13A and 13B are longitudinal sections through pen optics;

FIG. 14 is a ray trace for the pen optics alongside the pen cartridge;

FIG. 15A is a captured image showing the image sensor out of X-Y alignment with the optical mask;

FIG. 15B is a captured image showing the image sensor in X-Y alignment with the optical mask;

FIG. 16 shows a uniform binary noise target image;

FIG. 17 shows a star pattern target image;

FIG. 18 shows the relationship of high frequency component amplitude vs offset;

FIG. 19 is a perspective of the optical alignment machine;

FIG. 20 is a front elevation of the optical alignment machine; and,

FIG. 21 is a side elevation of the optical alignment machine.

### DETAILED DESCRIPTION OF PREFERRED EMBODIMENTS

Alignment of an image sensor with its associated optics is critical to the quality of the image data captured. Excessive blur will render the output from the sensor useless particularly if the image data relates to a coding pattern such as that used in the Netpage system. Details of the Netpage system and the image capture system is described in detail in U.S. Ser. No. 12/477,877 (Our Docket NPS168US) filed Jun. 3, 2009, the contents of which are hereby incorporated by reference.

The invention will be described with reference to its application to a Netpage pen. However, it will be appreciated that it is not restricted to this application and may be equally applied to many other areas of optical sensing.

The Netpage system relies on successfully imaging the Netpage code pattern. Image capture with the Netpage stylus (pen) is complicated by grip variations and changes in pen orientation when writing or otherwise marking the coded surface. The optical imaging system requires a large depth of focus to accommodate the full range of likely pen poses.

The level of de-focus, or blur, must be kept within set thresholds at the extremes of the pen pose range. Having designed a sensor and optical components that theoretically meet the blur thresholds at the pose limits, assembly of the sensor and the optical components need to be precise. Minute displacement of the lens along optical axis can cause excessive blur at the extremes of the permissible pose range. Hence the optical components and the sensor need to be assembled to precise tolerances. Precision assembly is typically unsuitable for high volume production. If unit costs become exorbitant, the price exceeds that which the market will bear.

In the optical alignment techniques described below, the individual components of the optical sub-assembly are not manufactured to very precise tolerances. The defocus in the image sensed by the image sensor is determined at points distributed throughout the pose range. By interpolating between the defocus levels at the various points, the position of best focus is determined for each lens.

### 1. NETPAGE PEN

### 1.1 Introduction and Functional Overview

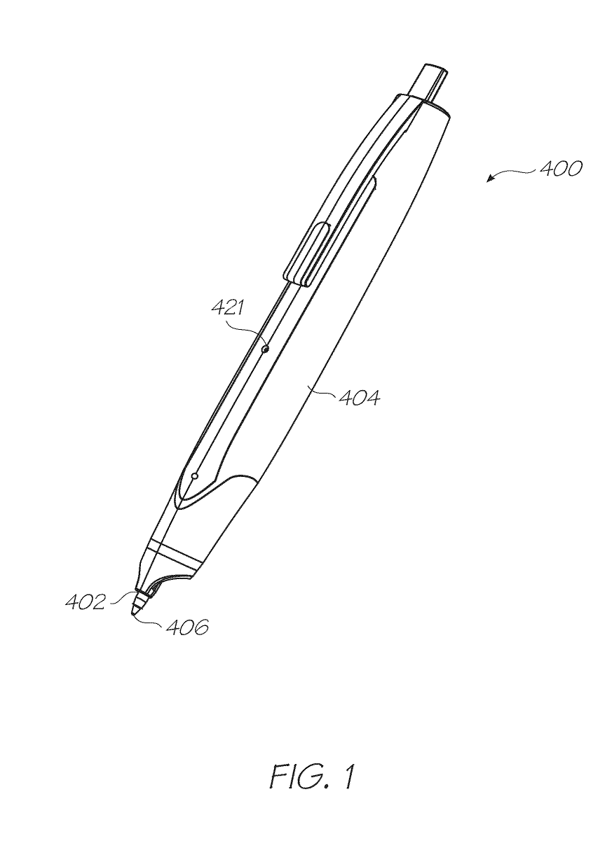

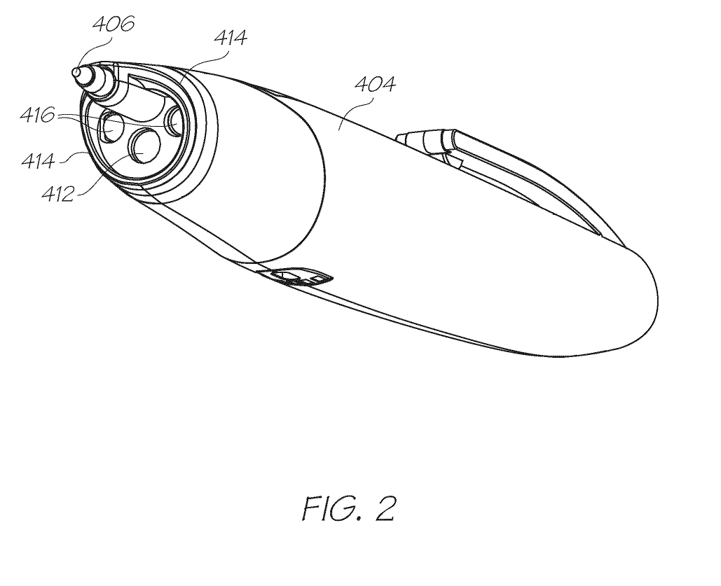

The Netpage pen 400 shown in FIGS. 1 and 2 is a motion-sensing writing instrument which works in conjunction with a tagged Netpage surface (see U.S. Ser. No. 12/477,877 cross referenced above). The Netpage pen 400 typically includes a conventional ballpoint pen cartridge and nib 406 for marking the surface, an image sensor 412 and processor for capturing the absolute path of the pen on the surface and identifying the surface, a force sensor for simultaneously measuring the force exerted on the nib, an optional Gesture button for indicating that a Gesture is being captured, and a real-time clock for simultaneously measuring the passage of time.

During normal operation, the Netpage pen 400 regularly samples the encoding of a surface as it is traversed by the Netpage pen's nib 406. The sampled surface encoding is decoded by the Netpage pen 400 to yield surface information comprising the identity of the surface, the absolute position of the nib 406 of the Netpage pen on the surface, and the pose of the Netpage pen relative to the surface. The Netpage pen also incorporates a force sensor that produces a signal representative of the force exerted by the nib 406 on the surface.

Each stroke is delimited by a pen down and a pen up event, as detected by the force sensor. Digital Ink is produced by the Netpage pen as the timestamped combination of the surface information signal, force signal, and the Gesture button input. The Digital Ink thus generated represents a user's interaction with a surface—this interaction may then be used to perform corresponding interactions with applications that have pre-defined associations with portions of specific surfaces. (In general, any data resulting from an interaction with a Netpage surface coding is referred to herein as “interaction data”).

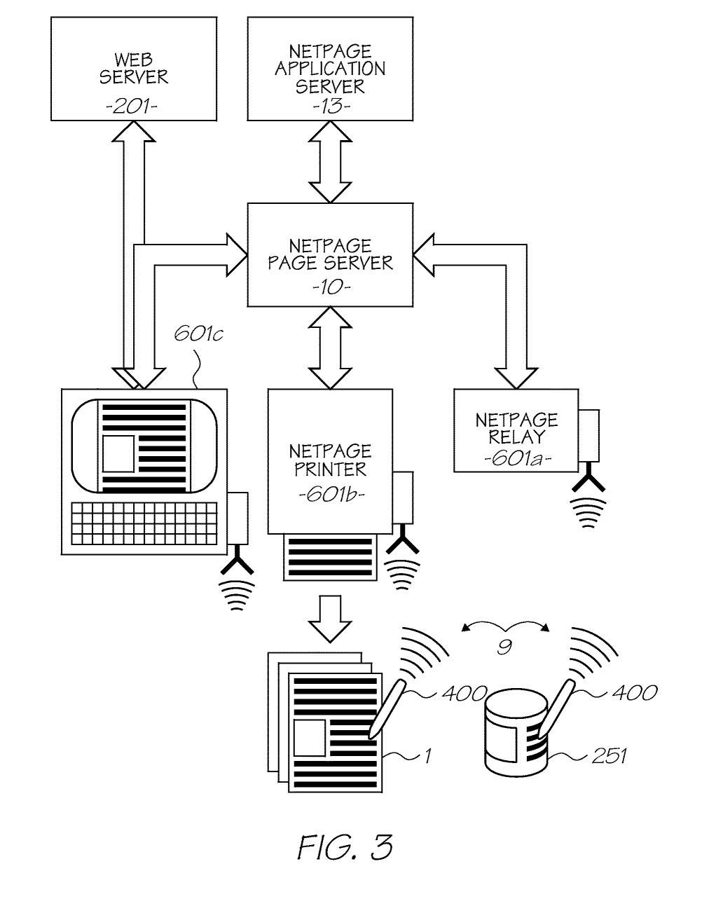

FIG. 3 is a schematic representation of the Netpage system. Digital Ink is ultimately transmitted to the Netpage server 10, but until this is possible it may be stored within the Netpage pen's internal non-volatile memory. Once received by a Netpage server 10, the Digital Ink may be subsequently rendered in order to reproduce user mark-ups on surfaces such as annotations or notes, or to perform handwriting recognition. A category of Digital Ink known as a Gesture also exists that represents a set of command interactions with a surface. (Although the Netpage server 10 is typically remote from the pen 400 as described herein, it will be appreciated that the pen may have an onboard computer system for interpreting Digital Ink).

The pen 400 incorporates a Bluetooth radio transceiver for transmitting Digital Ink to a Netpage server 10, usually via a relay device 601a but the relay maybe incorporated into the Netpage printer 601b. When operating offline from a Netpage server, the pen buffers captured Digital Ink in non-volatile memory. When operating online to a Netpage server the pen transmits Digital Ink in real time as soon as all previously buffered Digital Ink has been transmitted.

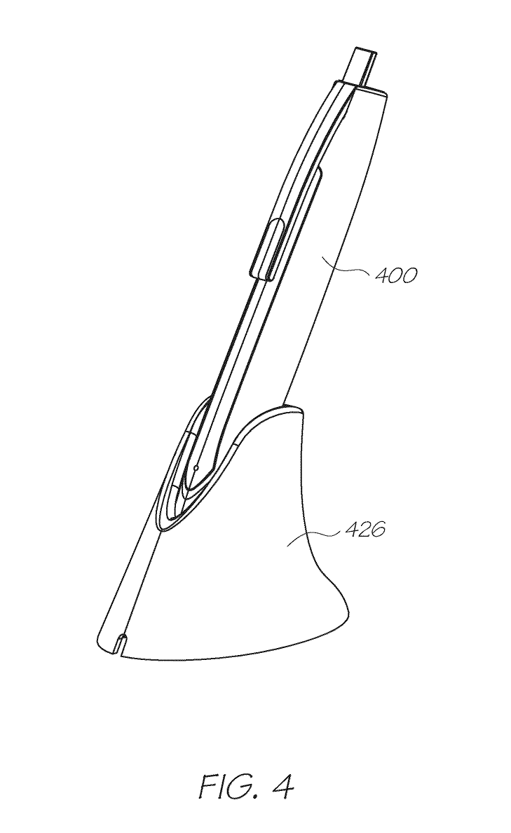

FIG. 4 shows the Netpage pen 400 in its charging cradle 426 referred to as a Netpage pen cradle. The Netpage pen cradle 426 contains a Bluetooth to USB relay and connects via a USB cable to a computer which provides communications support for local applications and access to Netpage services.

The Netpage pen 400 is powered by a rechargeable battery. The battery is not accessible to or replaceable by the user. Power to charge the Netpage pen is usually sourced from the Netpage pen cradle 426, which in turn can source power either from a USB connection, or from an external AC adapter.

The Netpage pen's nib 406 is user retractable, which serves the dual purpose of protecting surfaces and clothing from inadvertent marking when the nib is retracted, and signalling the Netpage pen to enter or leave a power-saving state when the nib is correspondingly retracted or extended.

### 1.2 Ergonomics and Layout

The overall weight (40 g), size and shape (155 mm×19.8 mm×18 mm) of the Netpage pen 400 fall within the bounds of conventional handheld writing instruments.

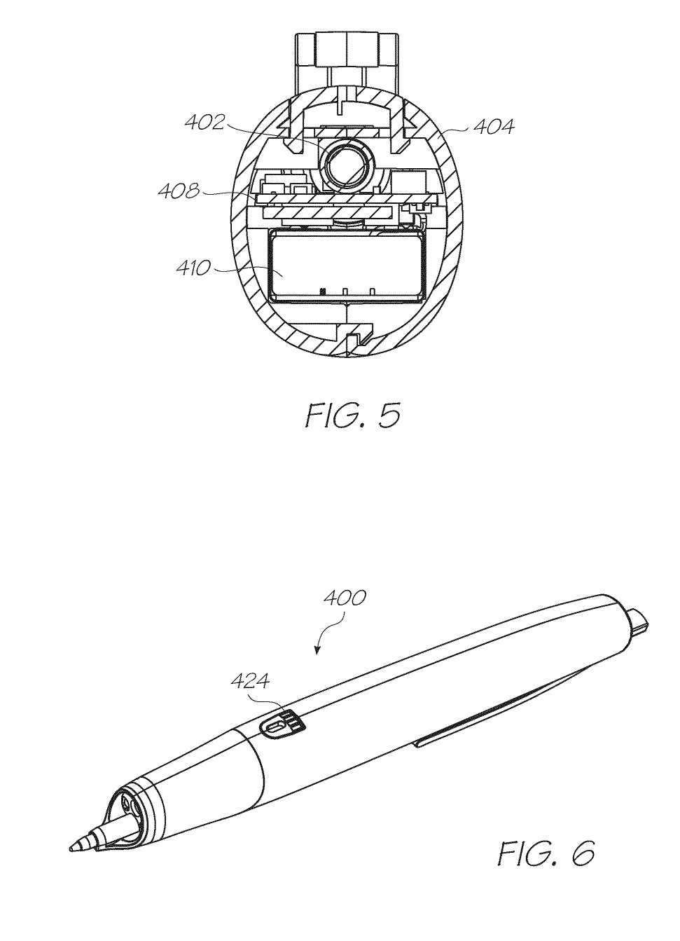

Referring to FIG. 5, a rounded casing 404 gives the pen an ergonomically comfortable shape to grip when the Netpage pen 400 is used in the correct functional orientation. It is also a practical shape for accommodating the internal components—the main PCB 408, battery 410 and ballpoint cartridge 402.

A user typically writes with the Netpage pen 400 at a nominal pitch of about 30 degrees from the normal toward the hand when held (positive angle) but seldom operates the Netpage pen at more than about 10 degrees of negative pitch (away from the hand). The range of pitch angles over which the Netpage pen is able to image the pattern on the paper has been optimized for this asymmetric usage. The shape of the Netpage pen assists with correct orientation in a user's hand.

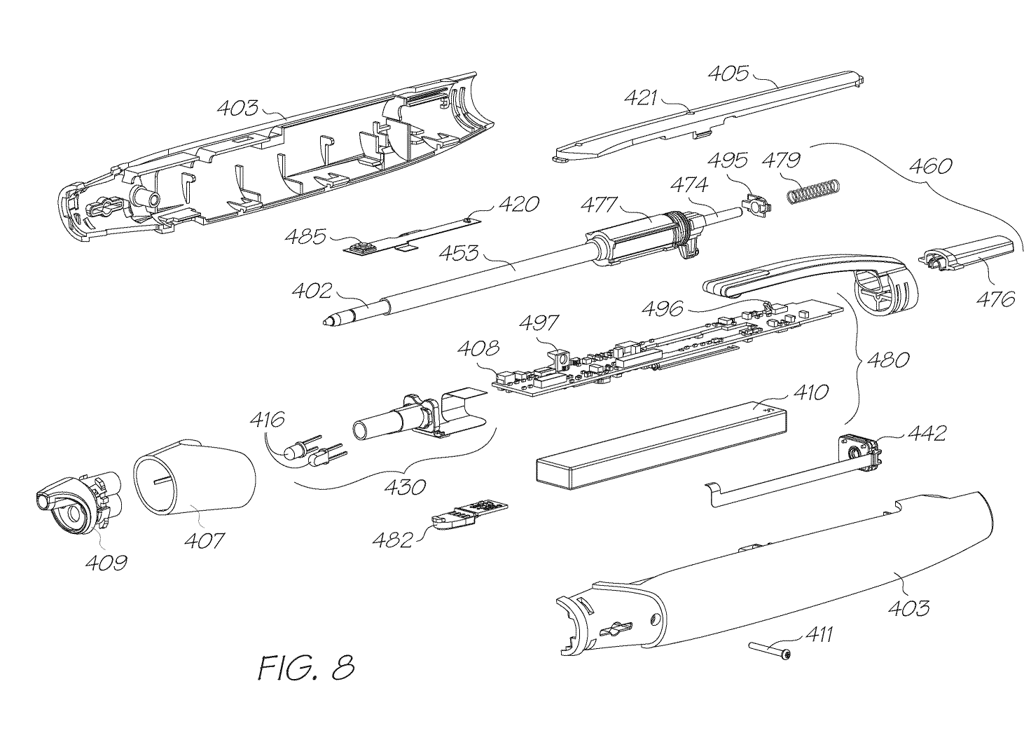

One or more colored user feedback LEDs 420 (see FIG. 8) illuminate corresponding indicator window(s) 421 on the upper surface of the Netpage pen 400. The indicator window(s) 421 remain unobscured when the Netpage pen 400 is held in a typical writing position.

Referring again to FIG. 5, a ballpoint pen cartridge 402 is housed in an upper portion of the Netpage pen's housing 404, placing it consistently with respect to the user's grip and providing good user visibility of the nib 406 whilst the Netpage pen 400 is in use. The space below the ballpoint pen cartridge 402 is used for the main PCB 408 (which is situated in the centre of the Netpage pen 400) and for the battery 410 (which is situated in the base of the Netpage pen). As shown in FIG. 2, the tag-sensing optics 412 are placed unobtrusively below the nib (with respect to nominal pitch).

The ballpoint pen cartridge 402 is front-loading to simplify coupling to an internal force sensor 442.

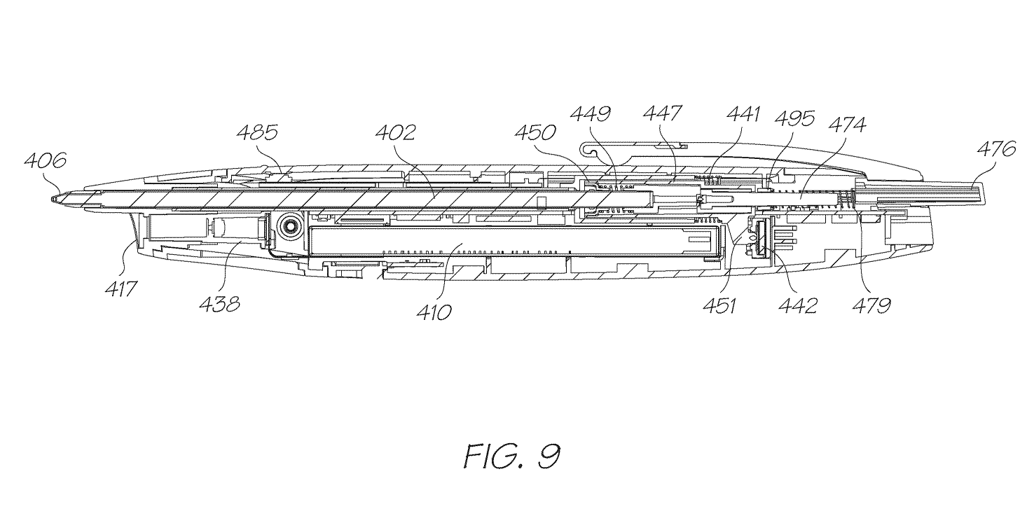

Still referring to FIG. 2, the nib molding 414 of the Netpage pen 400 is swept back below the ballpoint pen cartridge 402 to prevent contact between the nib molding and the paper surface when the Netpage pen is operated at maximum pitch. The Netpage pen's optics 412 and a pair of near-infrared illumination LEDs 416 are situated behind a filter window 417 (see FIG. 9) located below the nib—the Netpage pen's imaging field of view emerges through this window, and the illumination LEDs also shine through this window. The use of two illumination LEDs 416 ensures a uniform illumination field. The LEDs can also be controlled individually so as to allow dynamic avoidance of undesirable reflections when the Netpage pen is held at some angles, especially on glossy paper.

### 1.3 Netpage Pen Feedback Indications

The Netpage pen 400 may incorporate one or more visual user indicators 420 that are used to convey the pen status to a user, such as battery status, online status and/or capture blocked status. Each indicator 420 illuminates a shaped aperture or diffuser in the Netpage pen's housing 404—the shape of the aperture or diffuser is typically an icon that corresponds to the nature of the indication. An additional battery status indicator used to indicate charging state is also visible from the top-rear of the Netpage pen whilst the pen is inserted in to the Netpage pen cradle.

An optional battery status indicator typically comprises a red and a green LED and provides feedback on remaining battery capacity and charging state to a user. An optional online status indicator typically comprises a green LED which provides feedback on the state of a connection to a Netpage server, and also provides feedback during Bluetooth pairing operations.

### 1.3.1 Capture Blocked Indicator

The capture blocked indicator comprises a red LED and provides error feedback when Digital Ink capture is blocked. There may be a number of conditions under which the Netpage pen 400 is incapable of capturing digital ink, or is incapable of capturing digital ink of adequate quality.

For example, the pen 400 may be unable to capture (adequate quality) digital ink from a surface because it is unable to image the tag pattern on the surface or decode the imaged tag pattern. This may occur under a number of conditions:
the surface is not tagged
the pen's field of view is slightly or fully off the edge of the tagged surface
the tag pattern is poorly printed (e.g. due to printing errors, or to the use of a poor-quality print medium)
the tag pattern is damaged (e.g. the tag pattern is faded or smeared, or the surface is scratched or dirty)
the tag pattern is counterfeit (i.e. it contains an invalid digital signature)
the pen's tilt is excessive (i.e. causing excessive geometric distortion, defocus blur and/or poor illumination)
the pen's speed is excessive (i.e. causing excessive motion blur)
the tag pattern is obscured by specular reflection (i.e. from the surface itself or from the printed tag pattern or graphics)

The pen may be unable to store digital ink because its internal buffer is full.

The pen may also choose not to capture digital ink under a number of circumstances:
the pen is not registered (as indicated by the pen's own internal record, or by the server)
the pen is not connected (i.e. to a server)
the pen has been blocked from capturing (e.g. on command from the server)
the pen's user has not been authenticated (e.g. via a biometric such as a fingerprint or handwritten signature or password)
the pen is stolen (i.e. as reported by the server)
the pen's ink cartridge is empty (e.g. the pen is a universal pen as described in U.S. Pat. No. 6,808,330, the contents of which are incorporated herein by reference, so its ink consumption is easily monitored)

The pen may also choose to not to capture digital ink if it detects an internal hardware error, such as a malfunctioning force sensor.

The visual capture blocked indicator LED 420 typically indicates to the user that digital ink capture is blocked, e.g. due to one of the conditions described above. This indicator LED 420 may also be used to indicate when capture is close to being blocked, such as when the tag pattern decoding rate drops below a threshold, or the tilt or speed of the pen becomes close to excessive, or when the pen's digital ink buffer is almost full.

### 1.4 Netpage Pen Cradle 426

As shown in FIG. 6, the Netpage pen's cradle contacts 424 are located beneath the nose cone 409. These contacts 424 connect with a set of corresponding contacts in the Netpage pen cradle 426 upon insertion, and are used for charging the Netpage pen 400.

FIG. 4 shows the Netpage pen 400 docked in the Netpage pen cradle 426. The Netpage pen cradle 426 is compact to minimize its desktop footprint, and has a weighted base for stability. Data transfer occurs between the Netpage pen 400 and the Netpage pen cradle 426 via a Bluetooth radio link.

The Netpage pen cradle 426 may have two visual status indicators—a power indicator, and an online indicator. The power indicator is illuminated whenever the Netpage pen cradle 426 is connected to a power supply—e.g. an upstream USB port, or an AC adapter. The online indicator provides feedback when the Netpage pen 400 has established a connection to the Netpage pen cradle 426, and during Bluetooth pairing operations.

There are two main functions that are required by the Netpage pen cradle 426:
provide a source of charge current so that the Netpage pen 400 can recharge its internal battery 410.
provide host communications Bluetooth wireless endpoint for the Netpage pen 400 to connect to in order to ultimately communicate with the Netpage server 10.

The Netpage pen cradle 426 has a built-in cable which ends in a single USB A-side plug for connecting to an upstream host. In order to provide sufficient current for normal charging of the Netpage pen's battery 410, the Netpage pen cradle 426 is typically connected to a root hub port, or a port on a self-powered hub. A second option for providing charging-only operation of the Netpage pen cradle 426 is to connect the USB A-side plug to an optional AC adapter.

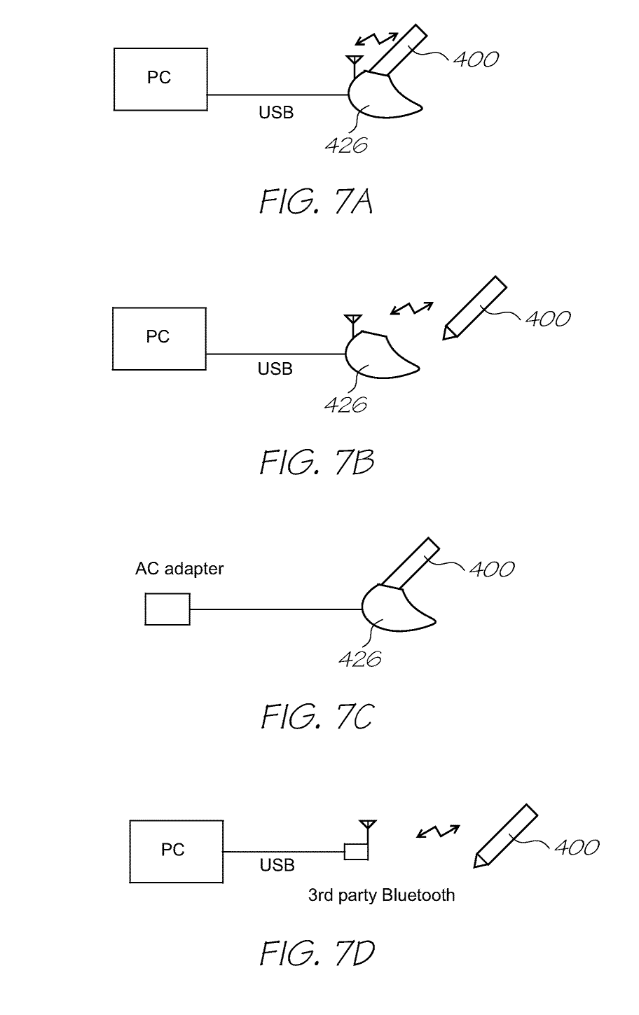

FIGS. 7A to 7D show the main charging and connection options for the Netpage pen 400 and Netpage pen cradle 426. FIG. 7A shows a USB connection from a host (e.g. PC) to the Netpage pen cradle 426. The Netpage pen 400 is seated in the Netpage pen cradle 426, and the Netpage pen cradle and the Netpage pen communicate wirelessly via Bluetooth. The Netpage pen cradle 426 is powered by a USB bus power and the Netpage pen 400 is charged from the USB bus power. As a result, the maximum USB power of 500 mA must be available in order to charge the pen at the normal rate.

FIG. 7B shows a USB connection from a host (e.g. PC) to the Netpage pen cradle 426. The Netpage pen 400 in use, and the cradle and pen communicate wirelessly via Bluetooth. The Netpage pen cradle 426 is powered by the USB bus power.

FIG. 7C shows an optional AC adapter connected to the Netpage pen cradle 426. The Netpage pen 400 is seated in the Netpage pen cradle 426, and is charged from current supplied by the optional AC adapter.

FIG. 7D shows the Netpage pen in use. In this case, the Netpage pen is communicating to a host (e.g. PC) wirelessly using 3rd party Bluetooth which may be, for example, integrated into a laptop or mobile phone. The Netpage pen cradle 426 contains a CSR BlueCore4 device. The BlueCore4 device functions as a USB to Bluetooth bridge and provides a completely embedded Bluetooth solution.

### 1.5 Mechanical Design

### 1.5.1 Parts and Assemblies

Referring to FIGS. 8 and 9, the pen 400 has been designed as a high volume product and has four major sub-assemblies:

an optical assembly 430;

a force sensing assembly 440 including force sensor 442;

a nib refraction assembly 460, which includes part of the force sensing assembly;

a main assembly 480, which includes the main PCB 408 and battery 410.

These assemblies and the other major parts can be identified in FIG. 9. As the form factor of the pen is to be as small as possible these parts are packed as closely as practical.

The pen housing 404, which defines the body of the pen, is comprised of a pair of snap-fitting side moldings 403, a cover molding 405, an elastomer sleeve 407 and a nosecone molding 409. The cover molding 405 includes one or more transparent windows 421, which provide visual feedback to the user when the LEDs 420 are illuminated.

Although certain individual molded parts are thin walled (0.8 to 1.2 mm) the combination of these moldings creates a strong structure. The pen 400 is designed not to be user serviceable and therefore the elastomer sleeve 407 covers a single retaining screw 411 to prevent user entry. The elastomer sleeve 407 also provides an ergonomic high-friction portion of the pen, which is gripped by the user's fingers during use.

### 1.5.2 Optical Assembly 430

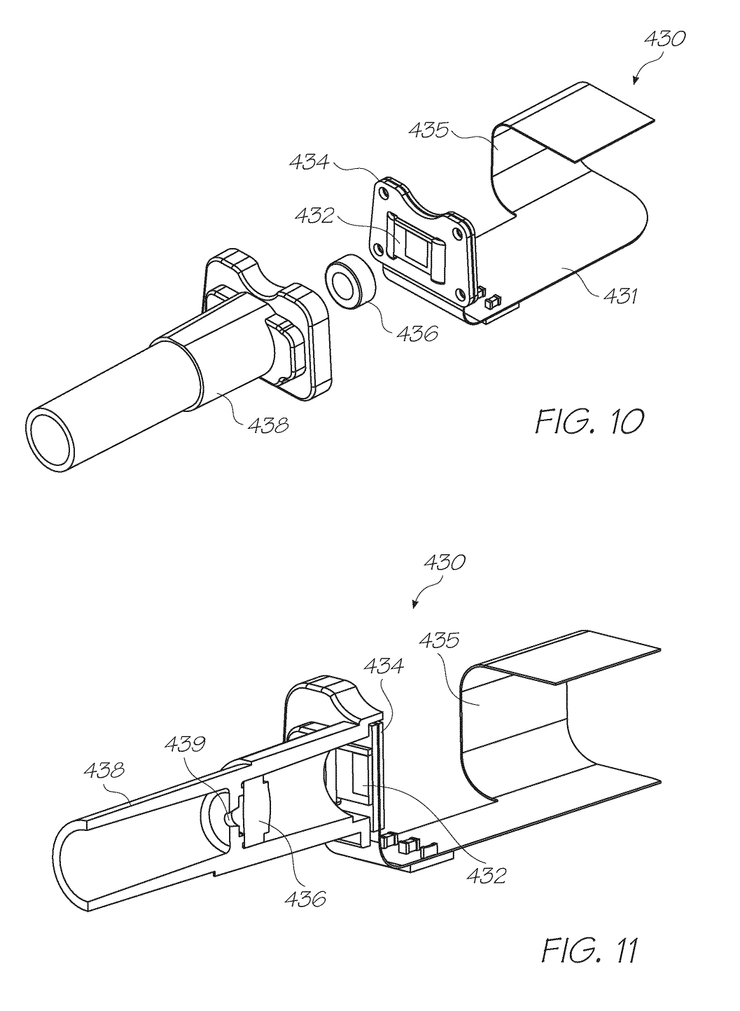

The major components of the optical assembly 430 are as shown in FIGS. 10 and 11. An optics PCB 431 has a rigid portion 434 and a flexible portion 435. A ‘Himalia’ image sensor 432 is mounted on the rigid portion 434 of the optics PCB 431 together with an optics barrel molding 438.

Since the critical positioning tolerance in the pen 400 is between the optics and the image sensor 432, the rigid portion 434 of the optics PCB 431 allows the optical barrel to be easily aligned to the image sensor. The optics barrel molding 438 has a molded-in aperture 439 near the image sensor 432, which provides the location of a focusing lens 436. Since the effect of thermal expansion is very small on a molding of this size, it is not necessary to use specialized materials.

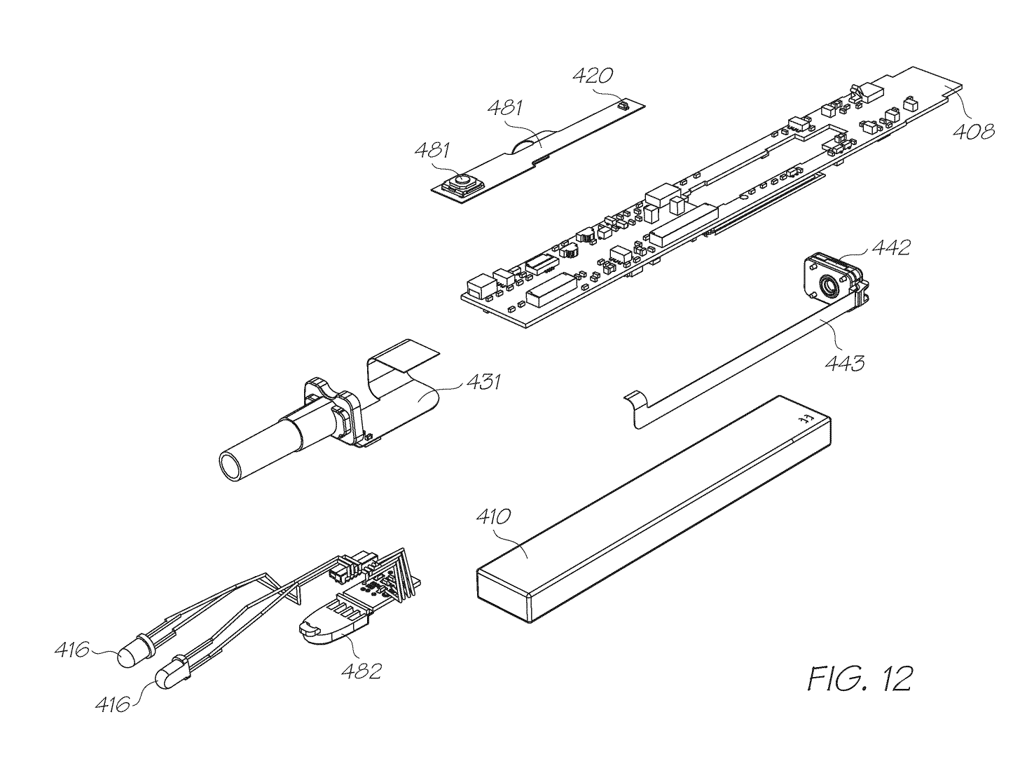

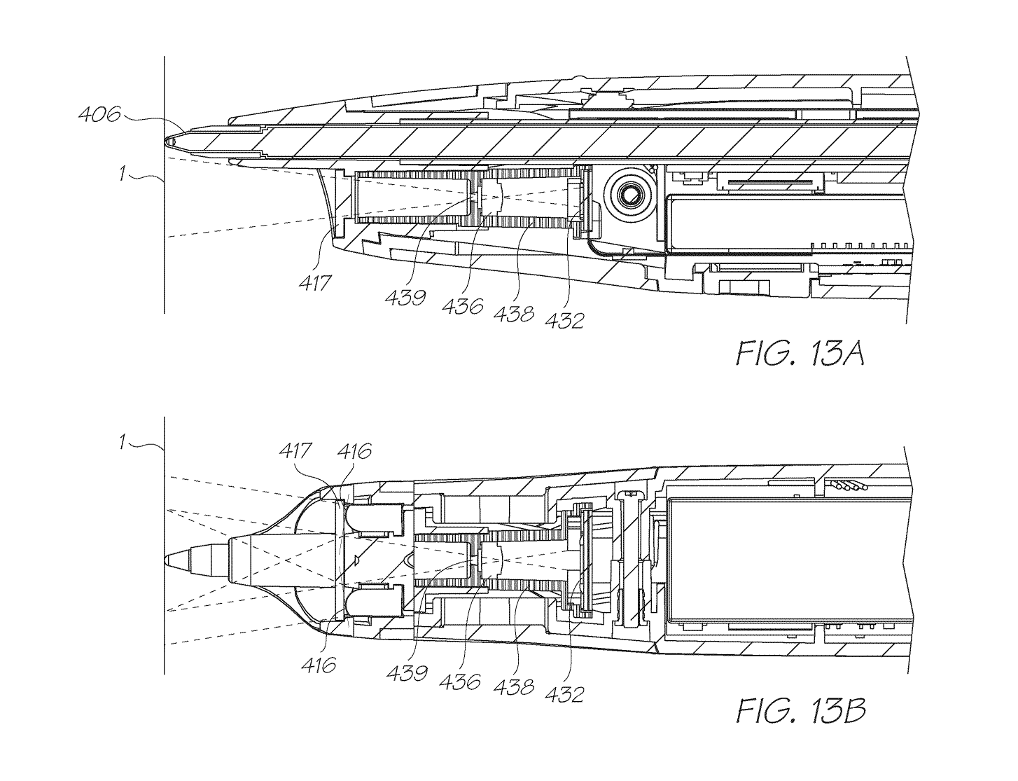

The flexible portion 435 of the optics PCB 431 provides a connection between the image sensor 432 and the main PCB 408. The flex is a 2-layer polyimide PCB, nominally 75 microns thick, which allows some manipulation during manufacture assembly. The flex 435 is L-shaped in order to reduce its required bend radius, and wraps around the main PCB 408. The flex 435 is specified as flex on install only, as it is not required to move after assembly of the pen. Stiffener is placed at the connector (to the main PCB 408) to make it the correct thickness for the optics flex connector 483A used on the main PCB (see FIG. 12). Discrete bypass capacitors are mounted onto the flex portion 435 of the optics PCB 431. The flex portion 435 extends around the main PCB 408, and widens to the rigid portion 434 at the image sensor.

The Himalia image sensor 432 is mounted onto the rigid portion 434 of the optics PCB 431 using a chip on board (COB) PCB approach. In this technology, the bare Himalia image sensor die 432 is glued onto the PCB and the pads on the die are wire-bonded onto target pads on the PCB. The wire-bonds are then encapsulated to prevent corrosion. Four non-plated holes in the PCB next to the die 432 are used to align the PCB to the optical barrel 438. The optical barrel 438 is then glued in place to provide a seal around the image sensor 432. The horizontal positional tolerance between the centre of the optical path and the centre of the imaging area on the image sensor die 432 is ±50 microns. In order to fit in the confined space at the front of the pen 400, the Himalia image sensor die 432 is designed so that the pads required for connection in the Netpage pen 400 are placed down opposite sides of the die.

### 1.6 Optical Design

The pen incorporates a fixed-focus narrowband infrared imaging system. It utilizes a camera with a short exposure time, small aperture, and bright synchronized illumination to capture sharp images unaffected by defocus blur or motion blur.

TABLE 1
Optical Specifications

| Magnification | ^{~}0.248 | |
|---|---|---|
| Focal length of lens | 6.069 | mm |
| Total track length | 41.0 | mm |
| Aperture diameter | 0.7 | mm |
| Depth of field | ^{~}/5.0 | mm^{a} |
| Exposure time | 100 | us |
| Wavelength | 810 | nm^{b} |
| Image sensor size | 256 × 256 pixels | |
| Pixel size | 8 | um |
| Pitch range^{c} | ^{~}22.5 to 45 deg | |
| Roll range | ^{~}45 to 45 deg | |
| Yaw range | 0 to 360 deg | |
| Minimum sampling rate | 2.0 pixels per macrodot | |
| Maximum pen velocity | 0.5 | m/s |

^{a}Allowing 63.5 um blur radius
^{b}Illumination and filter
^{c}Pitch, roll and yaw are relative to the axis of the pen.

### 1.6.1 Pen Optics Overview

Cross sections showing the pen optics are provided in FIGS. 13A and 13B. An image of the Netpage tags printed on the surface 1 (see FIG. 3) adjacent to the nib 406 is focused by a lens 436 onto the active region of the image sensor 432. The small aperture 439 is dimensioned such that the depth of field accommodates the required pitch and roll ranges of the pen.

A pair of LED's 416 brightly illuminate the surface within the field of view. The spectral emission peak of the LED's 416 is matched to the spectral absorption peak of the infrared ink used to print Netpage tags so as to maximize contrast in captured images of tags. The brightness of the LED's 416 is matched to the small aperture size and short exposure time required to minimize defocus and motion blur.

A longpass filter window 417 suppresses the response of the image sensor 432 to any colored graphics or text spatially coincident with imaged tags 4 and any ambient illumination below the cut-off wavelength of the filter. The transmission of the filter 417 is matched to the spectral absorption peak of the infrared ink in order to maximize contrast in captured images of tags 4. The filter 417 also acts as a robust physical window, preventing contaminants from entering the optical assembly 412.

### 1.6.2 Imaging System

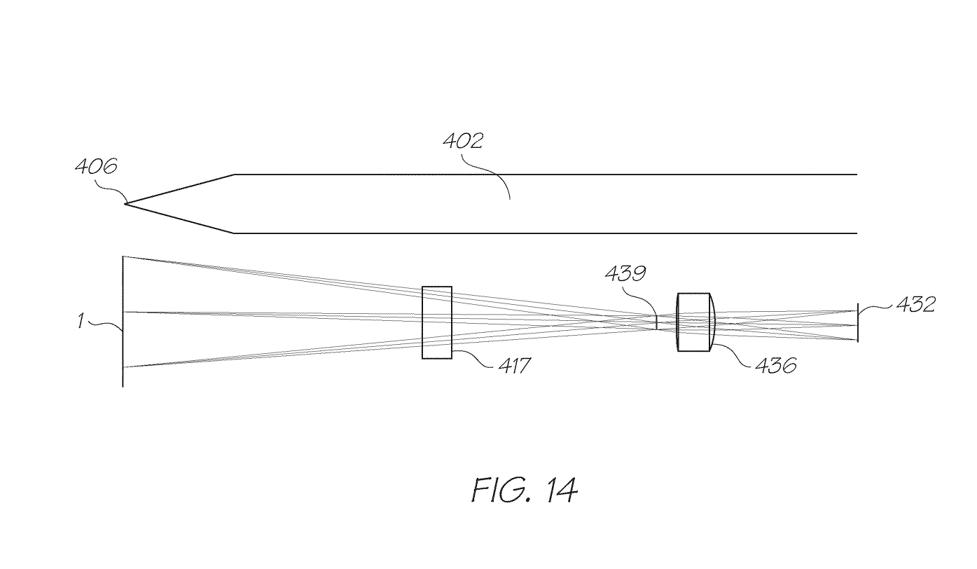

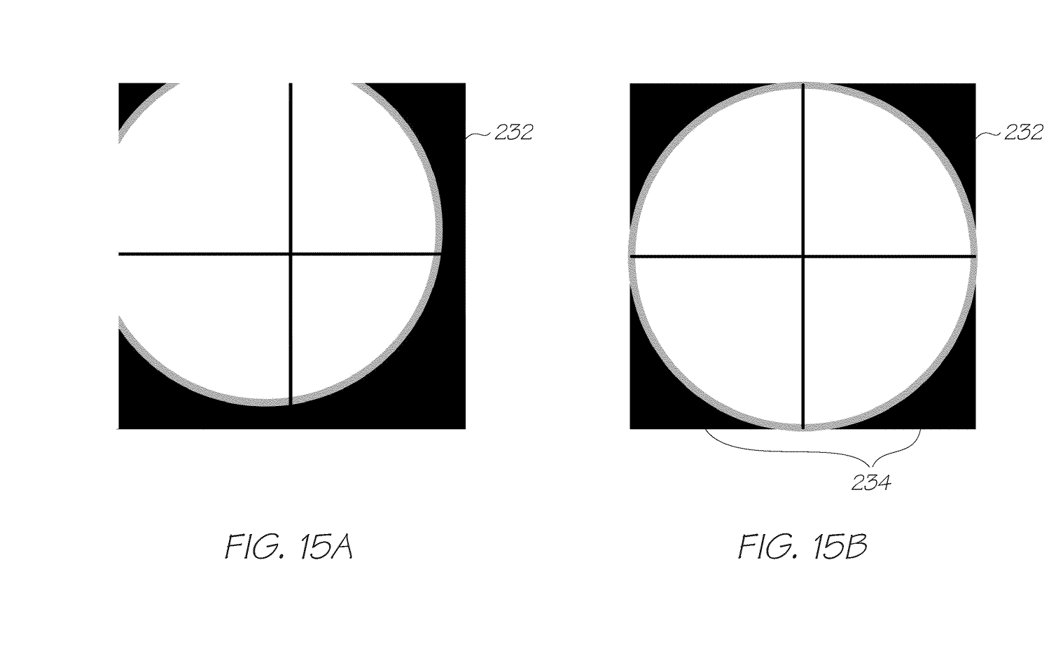

A ray trace of Netpage pen's optic path is shown in FIG. 14. The image sensor 432 is a CMOS image sensor with an active region of 256 pixels squared. Each pixel is 8 microns squared, with a fill factor of 50%.

The nominal 6.069 mm focal length lens 436 is used to transfer the image from the object plane (paper 1) to the image plane (image sensor 432) with the correct sampling frequency to successfully decode all images over the specified pitch, roll and yaw ranges. The lens 436 is biconvex, with the most curved surface being aspheric and facing the image sensor 432. The minimum imaging field of view required to guarantee acquisition of an entire tag 4 has a diameter of 46.7 s (where s is a macrodot spacing) allowing for arbitrary alignment between the surface coding and the field of view. Given a macrodot spacing, s, of 127 microns, the required field of view is 5.93 mm.

The required paraxial magnification of the optical system is defined by the minimum spatial sampling frequency of 2.0 pixels per macrodot for the fully specified tilt range of the pen, for the image sensor of 8 micron pixels. Thus, the imaging system employs a paraxial magnification of −0.248, the ratio of the diameter of the inverted image (1.47 mm) at the image sensor to the diameter of the field of view (5.93 mm) at the object plane, on an image sensor of minimum 224×224 pixels. The image sensor 432 however is 256×256 pixels, in order to accommodate manufacturing tolerances. This allows up to ±256 microns (32 pixels in each direction in the plane of the image sensor) of misalignment between the optical axis and the image sensor axis without losing any of the information in the field of view.

The lens 436 is made from Poly-methyl-methacrylate (PMMA), typically used for injection moulded optical components. PMMA is scratch resistant, and has a refractive index of 1.49, with 90% transmission at 810 nm. The transmission is increased to 98% by an anti-reflection coating applied to both optical surfaces. This also removes surface reflections which lead to stray light degradation of the final image contrast. The lens 436 is biconvex to assist moulding precision and features a mounting surface to precisely mate the lens with the optical barrel assembly. A 0.7 mm diameter aperture 439 is used to provide the depth of field requirements of the design.

### 1.7 Tilt Range

The specified tilt range of the pen is −22.5° to +45.0° pitch, with a roll range of −45.0° to +45.0°. Tilting the pen through its specified range moves the tilted object plane up to 5.0 mm away from the focal plane. The specified aperture thus provides a corresponding depth of field of ±5.0 mm, with an acceptable blur radius at the image sensor of 15.7 microns. To accommodate the asymmetric pitch range, the focal plane of the optics is placed 1.8 mm closer to the pen than the paper. This more nearly centralizes the optimum focus within the required depth of field.

The optical axis is parallel to the nib axis. With the nib axis perpendicular to the paper, the distance between the edge of the field of view closest to the nib axis and the nib axis itself is 2.035 mm.

The longpass filter 417 is made of CR-39, a lightweight thermoset plastic heavily resistant to abrasion and chemicals such as acetone. Because of these properties, the filter 417 also serves as a window. The filter is 1.5 mm thick, with a refractive index of 1.50. Like the lens, it has a nominal transmission of 90% which is increased to 98% with the application of anti-reflection coatings to both optical faces. Each filter 417 may be easily cut from a large sheet using a CO₂ laser cutter.

### 2 IMAGE SENSOR AND LENS ALIGNMENT TECHNIQUES

The optics barrel and the image sensor need to be combined into a single optical assembly for installation into the Netpage pen. This section describes the techniques and apparatus used to locate the image sensor at the position of best focus for the lens. As discussed in the Background of the Invention section, the optical assembly must have a large depth of field (Approx. 5 mm) because of the pose range of different pen grips. The image processor is capable of handling image blur up to a certain threshold. In light of this, the image sensor needs to be positioned relative to the lens so that the level of blur in images captured through the specified pose range of the pen, remains below the threshold. In existing optical assemblies of this type (such as coded sensing pens manufactured under license from Anoto Inc.), precise positioning of the image sensor and the lens is achieved by relying on fine manufacturing tolerances. High precision components and assembly drive up production costs.

### 2.1 Overview

This section gives an overview of focus measurement methods. Focus has a large effect on the quality of the images used for tag decoding, and thus has a direct relationship with the tag decoding performance. In particular, the optics in the Netpage pen must provide a large depth of field to allow the tagged surface to be decoded across a wide range of pen poses.

To measure the focus in an optical system, an image is captured using the optical configuration to be assessed, and a measure of the quality of the focus is derived from the sensed image data. The optical system in the Netpage pen is precision assembled using the following method:

1. A set of images is captured with the optics positioned over a range of offsets from the nominal focus position along the optical axis;

2. The quality of the focus, or conversely defocus or blur, is derived for each image;

3. A curve representing the quality of focus across the images is constructed from the focus estimates; and,

4. The position of the maximum value on the focus curve is found, which corresponds to the position of best focus

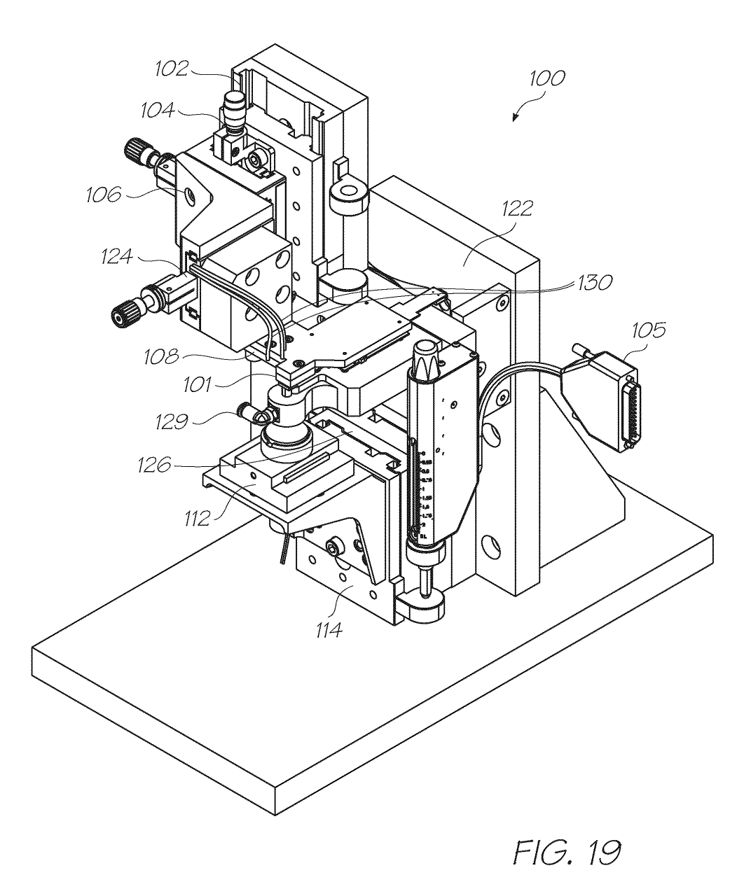

This offset is then used to accurately assemble the optics. For this method to be effective, an accurate technique for measuring the quality of focus from an image is required. For this, the image sensor alignment machine shown in FIGS. 19 to 21 is used.

### 2.2 X-Y Plane Alignment

Conventionally, the coordinate system used in optical alignment places the Z-axis along the optical axis of the lens. The focal plane is parallel to the X-Y plane. As an initial step, the centre of the image sensor 432 (see FIG. 10) is aligned with the Z-axis. The image sensor, already adhered to the image sensor PCB 431 (FIG. 10), is placed in the image sensor PCB holder 108. The optics barrel 438 is secured in the optics barrel holder 110.

A mask 232 (see FIGS. 15A and 15B) is imposed on the end of the optics barrel. The image sensor is illuminated through the mask and the optics barrel. The illumination source 112 shines through a diffuser plate 118 for uniform illumination. The mask is sized such that the corners of the image only impinge into the corners of the image sensor 432 when optimally centred as shown in FIG. 15B. Alignment is performed manually until an equal area of each corner of the image sensor us occluded by the image of the mask 232.

### 2.3 Target Patterns

Defocus is an optical aberration caused by an offset on the optical axis away from the point of best focus. Typically, defocus has a so called low-pass' filtering effect (i.e., blurring), reducing the sharpness and contrast in an image. The components of an image with a low spatial frequency, such as large shapes or areas, pass through the ‘filter’ and remain discernable while the high spatial frequency components, such as sharp edges and fine patterns, are lost—essentially ‘filtered out’ by the blur.

A target pattern is often used when measuring the degree of defocus in an image. Typically, the pattern has a known broadband frequency content, which allows the attenuation of the higher frequency components caused by the optical aberrations to be measured. The present techniques used target images with a frequency content that is substantially constant with changes of scale. That is, the broadband frequency content does not vary (much) as the target and lens, or target and images sensor, are moved relative to each other on the optical axis.

### 2.3.1 Random Target

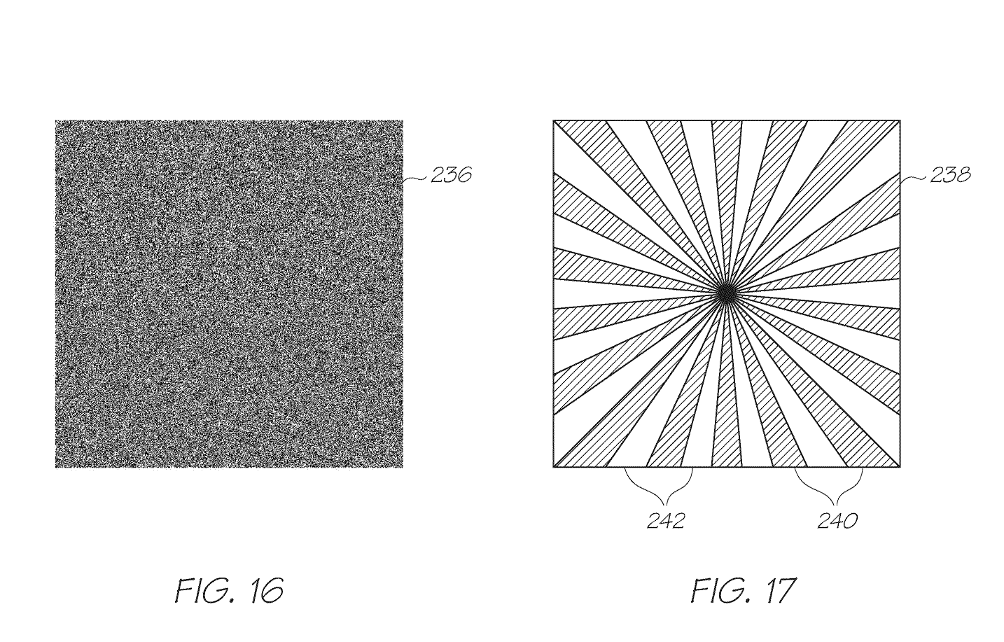

A random noise target image 236 is shown in FIG. 16. The random pattern was generated from a binary white noise image. Imaging an arbitrary window in the target will give a pattern with substantially constant broadband frequency content.

### 2.3.2 Star Target

FIG. 17 shows a start pattern target 238. The star pattern consists of a set of black (240) and white (242) segments radiating from a central point, with each segment subtending an angle of 10°. The star pattern is scale invariant around the central point, and thus produces images with constant frequency content at different offsets along the optical axis.

### 2.4 Image Sensor to Focal Plane Alignment

In order to provide acceptable performance over the complete pose range of the Netpage Pen, the image sensor must be correctly aligned along the Z axis relative to the optics barrel. When incorrectly aligned, defocus reduces the performance of the optical assembly which directly affects the overall performance of the Netpage Pen.

To find the point of best focus, a set of images of a target image (236 or 238) are captured with a range of translations along the optical axis. The target image is positioned such that it fills the entire field of view for the image sensor, and images are successively captured at 100 microns increments as the target image is translated from a position on one side of the object space focal plane, to a position on the opposing side of the object space focal plane.

For each image, the amplitude of high frequency content is measured and a curve modelling the relationship between offset and defocus is constructed. The position of best focus can then be estimated by finding the maxima of the curve. Deducing the difference between the position of best focus, and the desired position of best focus and converting this difference from object space to image space provides a Z axis offset through which the image sensor PCB must be translated.

The level of defocus blur in an image can be estimated from the proportion of high-frequency energy in a sensed image of the target image. One possible way to do this is to:

1. Perform a discrete Fourier transform of the image.

2. Calculate the magnitude spectrum of the image from the Fourier transform.

3. Normalize the spectrum to minimize variation due to illumination.

4. Calculate the amount of energy present in the higher-frequency bins.

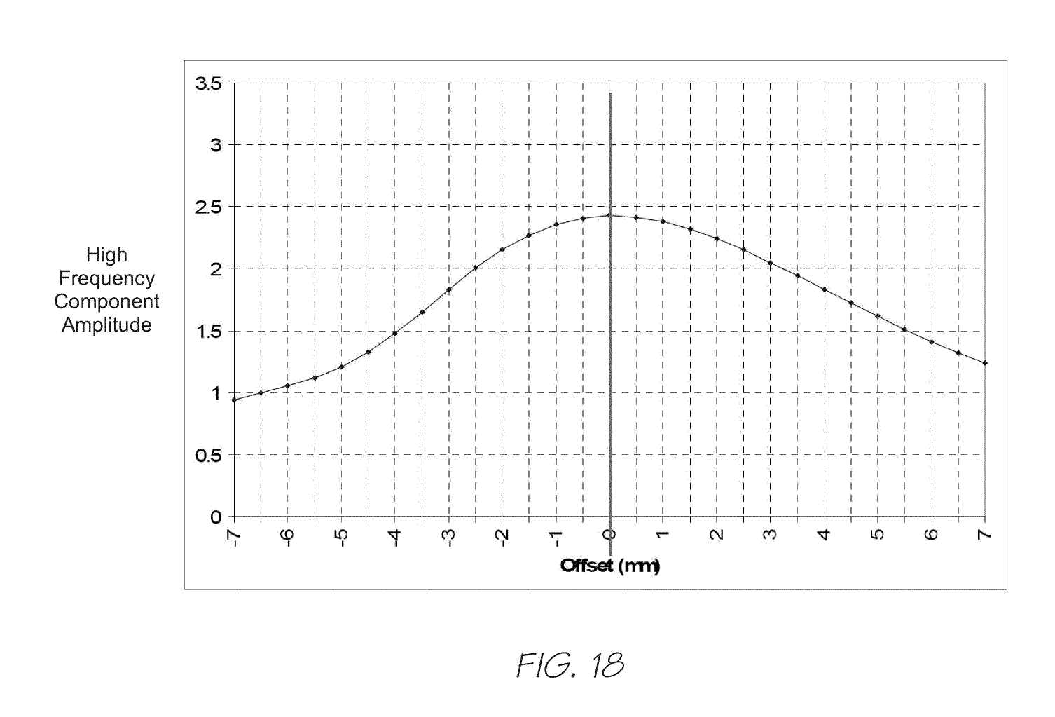

FIG. 18 is an example of a curve constructed using this technique. Note that image sensor noise, non-uniform illumination, and other forms of distortion can reduce the accuracy of the defocus calculation and should thus be minimized where possible.

Once the image sensor PCB is in the correctly adjusted location, the target is optionally moved to the nominal object space focal plane, and an image sample is captured and analysed in order to confirm that the image sensor is in fact at the correct location.

The image sensor PCB is adjusted such that the image space position of the front surface of the centre of the image sensor is no greater than ±31 microns from the position of best focus of the lens (corresponding to a maximum object space positional error of ±500 microns). This does not include a total allowable image sensor tilt of ±2° in the X and Y planes introduced through stack-up tilt tolerance in handling by the alignment machine, and image sensor PCB related tolerance.

### 3. MACHINE DESCRIPTION

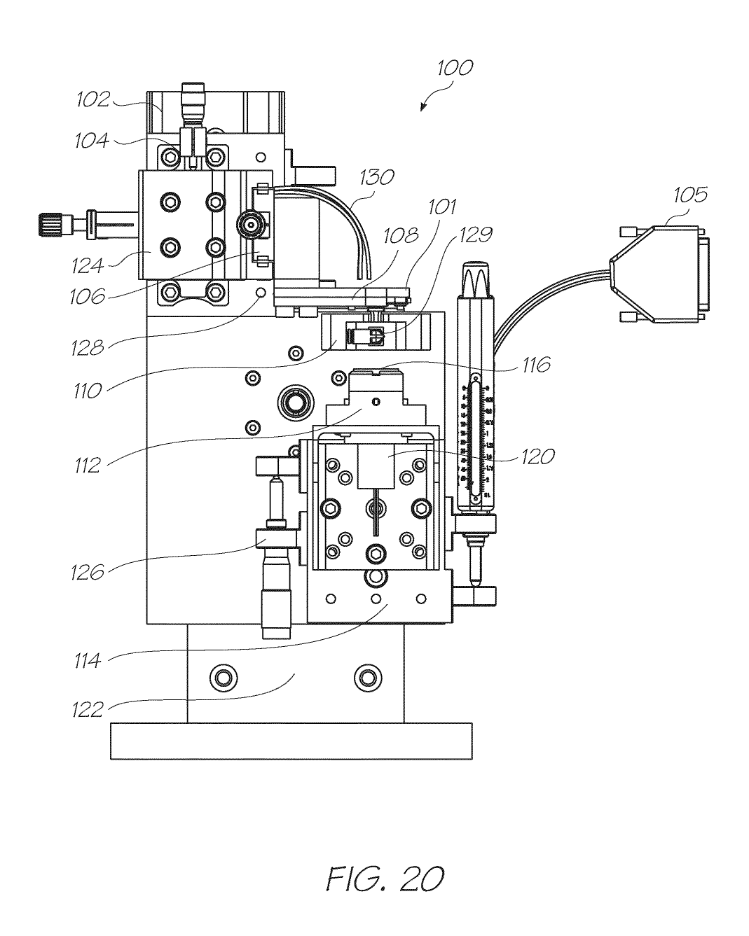

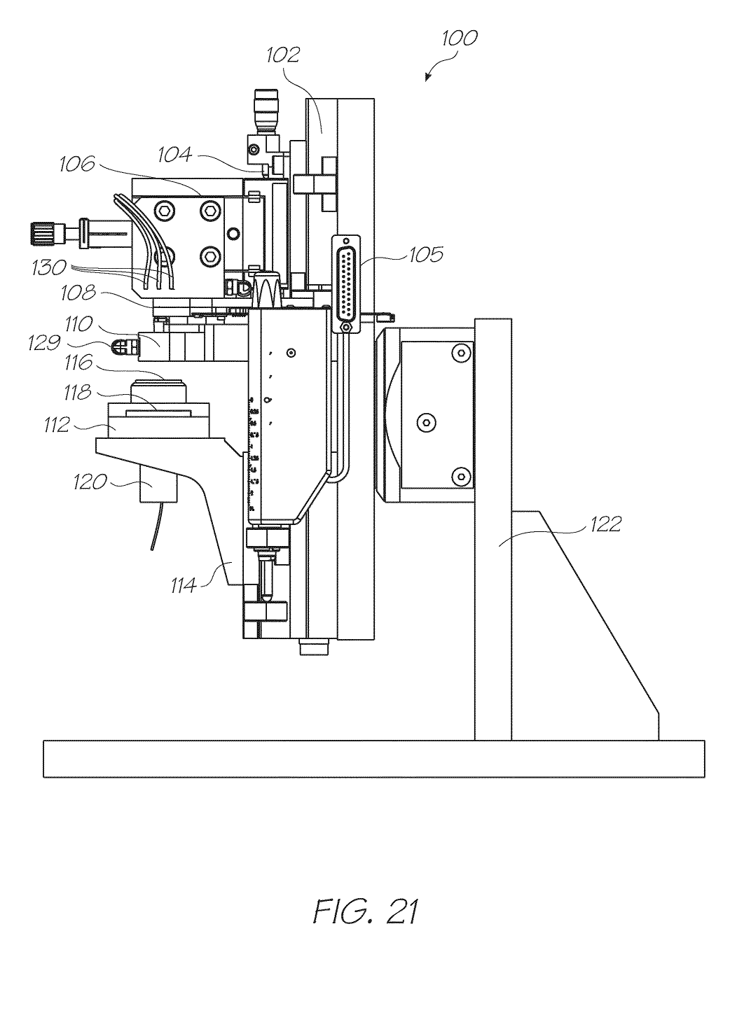

A perspective of the alignment machine 100 and its major components is shown in FIG. 19. A front view is shown in FIG. 20 and a side view is shown in FIG. 21.

### 3.1 Major Components

The vertical support 122 provides a rigid base and reinforced vertical arm upon which the remainder of the other components are mounted. The vertical support 122 is securely bolted to a mechanically damped surface such as an optical bench prior to machine operation.

The image sensor alignment stage 101 is comprised of a number of components, that together allow adjustment of the image sensor PCB holder assembly in X, Y and Z directions. It also allows for refraction of the stage for access to the optics barrel holder 110. Three stacked translation stages are used to provide fine adjustment of the image sensor PCB holder 108 in the X, Y and Z directions—the X and Y adjustments (124 and 106 respectively) are fitted with high resolution screws, whereas the Z adjustment 104 is fitted with a differential micrometer screw with a Vernier scale in microns that has low backlash and an adjustment range of at least 1000 μm.

Each translation stage has a travel of 25 mm, and straight line accuracy of at least 1 micron. Each stage provides preload against the corresponding actuator to control backlash. A fourth spring-loaded load/unload stage 102 with at least 30 mm travel is used to move the stacked X, Y, and Z translation stages (124, 106 and 126 respectively) and the image sensor PCB holder 108 away from the optics barrel when not in the locked position. This stage allows for insertion of an optics barrel into the optics barrel holder 110, and removal of a completed optical assembly.

When the load/unload stage 102 is moved downwards against the spring-force to the end-stop and locked, the stacked X, Y and Z translation stages and the image sensor PCB holder 108 is positioned such that the image sensor is ±100 microns off the nominal assembly position in the Z direction.

Initial alignment of the image sensor alignment stage (and hence the image sensor PCB holder 108) to the optics barrel holder 110 is adjusted as part of machine calibration so that a maximum ±50 microns Z axis error, and less than ±1° of tilt about the X and Y axes remains.

The image sensor PCB holder 108 secures the image sensor PCB such that the back side of the PCB is held flat against a surface that is aligned with the corresponding face of the optics barrel holder 110. The surface with which the image sensor PCB makes contact is flat and rigid, to conform to the rear side of the image sensor PCB, and is also shaped to permit access to the edges of the image sensor PCB to enable glue to be applied between the image sensor PCB and optics barrel once the image sensor PCB is correctly positioned.

The image sensor PCB is secured to the image sensor PCB holder 108 by a vacuum pick-up integrated into the surface that contacts the image sensor PCB. The vacuum is drawn through vacuum port 128. Four pins (not shown) are also provided that locate corresponding holes (see FIG. 10) in the hard section 434 of the image sensor PCB 431 to provide rotational alignment and additional stability during assembly.

The signal bearing flex PCB component 435 of the image sensor PCB 431 that extends beyond the hard section is guided by a channel in the image sensor PCB holder 108.

The image sensor PCB 431 interfaces with an image capture PCB (not shown). Reliable contact is made to the image sensor PCB by way of pogo pins or a ZIF (Zero Insertion Force) socket such that the contacts will survive at least 100,000 connection and disconnection cycles before requiring replacement.

The image capture PCB interfaces to a PC and provides the following functions:

1. Reset control of the image sensor.

2. Programming of image sensor capture parameters (exposure time, offset, and gain).

3. Capture of image sensor data and relaying of captured image sensor data to the PC.

4. PC controlled triggering of image capture, and corresponding control of the target illumination source.

The image capture PCB captures images from the image sensor and transfers these images to the PC at 60 fps or above.

The optics barrel holder 110 is affixed to the vertical support stand 122, and holds an optics barrel 438 for the duration of the alignment and assembly process. The optics barrel holder 110 has features that correspond to the outer surface of the optics barrel—a cylinder section that is compliant to the cylindrical portion of the outer surface of the optics barrel, and an alignment feature that accurately locates the corresponding shoulder alignment feature on the optics barrel.

An optics barrel 438 is held in place in the optics barrel holder 110 by way of vacuum drawn through vacuum port 129. The tolerance from the alignment feature on the optics barrel to the optics barrel holder 110 is controlled to within ±10 microns.

The optics barrel holder 110 incorporates the mask that restricts the field of view for performing image sensor X-Y alignment as described in Image sensor to optical axis alignment.

The target translation stage 114 features a two stacked translation stages, and a mounting point for the target and illumination assembly 112. The first translation stage is directly attached to the vertical support stand 122 and provides translation in the Z direction. This translation stage features a screw adjustment and provides 25 mm of travel for initial calibration time setup. A second motorised translation stage is stacked on top of the first translation stage. This translation stage provides at least 30 mm of travel in the Z direction, with repeatability in one direction to at least 100 microns±10 microns. When calibrated, this stage travels at 5 mm/s from a position +14.5 mm away from the nominal focal position to a position −14.5 mm away from the nominal focal position—this allows for a +7 mm to ±7 mm defocus vs. offset curve to be captured, including extra travel to account for a stack-up tolerance of ±7.5 mm in object space (or ±468 microns in image space). The motion of this stage is controlled by the PC. During setup time calibration, the first calibration stage is used to adjust the home zero point of the second motorised translation stage such that the target situated in the target holder 116 is located at 31.25 mm±50 microns from the mask at the bottom face of the optics barrel holder 110. The target 236 or 238 (see FIGS. 16 and 17) situated in the target holder 116 is also set to be at less than a ±1° angle relative to the bottom face of the optics barrel holder 110 about both X and Y axes.

The target and illumination assembly 112 is fitted to the corresponding mounting point on target translation stage 114, incorporates a fixed uniform noise target 236 or 238 for focus adjustment. Diffuse illumination is provided by illumination source 120 and diffuser plate 118. The target illumination source provides rear transmissive diffuse illumination of the uniform noise target. The illumination source provides output with a centre frequency of 810 nm and a half-maximum bandwidth of ±5 nm. Target illumination should be uniform in the sensor-visible portion of the target.

The focus adjustment target is fixed to the target and illumination assembly 112 and is centred on the optical axis of an optics barrel situated in the optics barrel holder.

A pneumatic adhesive dispenser is provided (not shown) for an operator to apply adhesive between the image sensor PCB and optics barrel for subsequent curing with a UV curing spot lamp. The adhesive dispenser is fitted with a syringe and fine bore needle for delivery of UV curable adhesive. A UV curing spot lamp is supplied for curing the applied adhesive, and is fitted with a 3 pole split light guide 103—the outputs of the light guide are fitted to an assembly that directs one pole to each of the three accessible edges of the optical assembly (i.e. excluding the edge from which the flex emerges), allowing three beads of adhesive applied to the image sensor PCB and optics barrel to be cured simultaneously.

A second hand-held UV curing spot lamp (not shown) is supplied for curing a bead of adhesive applied to the image sensor PCB and optics barrel on the edge from which the flex emerges. Appropriate shielding is provided (not shown) to protect an operator from UV-A emitted during the adhesive curing process.

Cable 103 connects to a PC which provides motion control of the target translation stage, emergency stop sensing, interfacing to the image capture PCB, image analysis, and operator GUI display. The target translation stage is connected to a motion controller that interfaces to the PC by way of a serial interface. Software running on the PC provides the required control signals according to the current state of assembly selected from the operator GUI.

An emergency stop button input for the machine also provides an input to the PC, and when actuated, halts any motion of the target translation stage until the system is explicitly reset by way of resetting the emergency stop button followed by re-initialisation by way of the operator GUI.

The operator GUI provides:
Machine reset
Machine initialisation
Machine configuration
Display of captured images
Control of assembly the operation sequence

### 3.2 Operating Procedure

Alignment and assembly of the optical assembly is performed in a number of stages. Each of these stages is outlined in the following sections with estimated elapsed time for each operation performed. The total assembly time per part for a single experienced operator performing the complete assembly process using the machine is less than 2 min in total and indeed estimated to be approximately 71 seconds.

### 3.2.1 Part Loading

1. The operator places an optics barrel into the optics barrel holder. (2 seconds)
2. The operator attaches an image sensor flex PCB is to the image sensor PCB holder assembly. (3 seconds)
3. The operator connects the image sensor flex PCB to the image capture PCB. (5 seconds)
4. The operator adjusts the Z stacked image sensor alignment stage to the nominal position using the coarse micrometer adjustment and resets the fine micrometer adjustment. (4 seconds)
5. The operator moves the image sensor alignment stage downwards into position and locks the stage into place. (2 seconds)
6. The operator powers on the image sensor flex connector and image capture PCB. (2 seconds) (1) Total: 18 seconds

### 3.2.2 Image Sensor X-Y Alignment

1. The operator adjusts the X and Y stacked image sensor alignment stages until the displayed image is correctly aligned (7 seconds).
Total: 7 seconds

### 3.2.3 Image Sensor Z Alignment

1. The operator uses the operator GUI provided by the PC to initiate focus adjustment image capture and image processing. (2 seconds)
2. The PC moves the target translation stage through the required range and captures an image for every 0.1 mm of travel. (6 seconds)
3. The PC calculates the point of best focus. (1 second)
4. The PC displays the required displacement of the image sensor PCB from the current position.
5. The operator adjusts the Z stacked image sensor alignment stage using the micrometer adjustment to achieve the required displacement. (3 seconds)
Total: 12 seconds

### 3.2.4 Assembly Part I

1. The operator uses the glue dispenser to place a bead of glue along the three accessible sides of the image sensor PCB such that the bead is in contact with both the image sensor PCB and optics barrel (the side of the PCB from which the flex emerges is glued in Assembly Part II, see below). (2 seconds×3 sides=6 seconds)
2. The operator activates the UV curing spot lamp for the curing interval. (5 seconds)
Total: 11 seconds

### 3.2.5 Part Unloading

1. The operator powers off the image sensor flex connector and capture PCB. (2 seconds)
2. The operator disconnects the image sensor flex from the image sensor flex connector and capture PCB. (5 seconds)
3. The operator unlocks the image sensor alignment stage and allows it to move upwards to the rest position. (2 seconds)
4. The operator removes the completed optical assembly from the optics barrel holder and places it in a temporary holding tray (not shown). (2 seconds)
Total: 11 seconds

### 3.2.6 Assembly Part II

1. The operator removes the aligned optical assembly from the temporary holding tray and places the optical assembly in a clamp. (2 seconds)
2. The operator uses the glue dispenser to place a bead of glue along the remaining side of the image sensor PCB (from which the flex emerges) such that the bead is in contact with both the image sensor PCB and optics barrel. (3 seconds)
3. The operator cures the glue using a hand-held UV curing lamp for the curing interval. (5 seconds).
4. The operator removes the optical assembly from the clamp and places it in a completed parts tray. (2 seconds)
Total: 12 seconds

### 4.0 EVALUATION OF FOCUS MEASUREMENT METHODS

A number of different focus measurement methods are presented. When comparing the results from these methods, the following metrics are used.

### 4.1 Accuracy

The most important characteristic of a focus measurement method is that it produces the correct result (i.e., the maximum value of the focus curve corresponds to the position of best focus). This metric is not useful when the position of best focus is not known (e.g., for real images as opposed to computer simulated images) or where all methods produce the same result.

### 4.2 Sharpness of the Curve

A focus curve that produces a sharp peak suggests that the focus measurement is accurately differentiating between well-focused and poorly focused images. The measurement is also likely to be less susceptible to biasing or offset effects, and should allow a more accurate estimate of the maxima position (e.g., using interpolation) than for a curve with a smoother (or flatter) peak.

### 4.3 Monotonicity

The focus measurement should be monotonic across the tested range, and should vary smoothly between successive measurements. If this is not true, ambiguity exists as to the true focal performance of the system.

### 4.4 Robust to Noise

A focus measurement should be robust to noise, meaning the accuracy of the result should not be sensitive to the amount of noise in the image.

### 4.5 Potential Issues

There are a number of potential issues that may arise when measuring the focus.

### 4.5.1 Fixed Target Resolution

The target pattern is typically in a fixed position during the focus measurements. Offsetting the optical system along the optical axis changes the distance between the optics and the target pattern. This in turn changes the effective resolution of the pattern. This may result in an error in the focus measurement, as the frequency content of the imaged target pattern will not be constant across all images.

### 4.5.2 Noise

In addition to the target pattern, the captured images also contain additive noise (e.g. image sensor noise, surface degradation). This noise can reduce the accuracy of the focus measurement, and introduce a bias that can move the position of the maximum value in the focus curve.

### 4.5.3 Illumination

The illumination across the target pattern should be uniform as possible within each image. All images used for the focus measurement should have a similar level of illumination. This is because the many focus measurement techniques measure signal energy levels, which are dependent on illumination.

### 5. TEST DATA

The focus testing was performed on both simulated and real images. Each test set consists of images captured or simulated with the optical system offset from the nominal position over the range −7 mm to 7 mm in increments of 0.5 mm. Unless otherwise specified, the random target pattern (see target 236 in FIG. 16) was used.

An additional set of test images were generated using the star pattern 238 (see FIG. 17) with the optical system offset from the nominal position over the range −1.5 mm to 1.5 mm in increments of 0.1 mm. The purpose of this additional data set is to allow a more precise assessment of the accuracy and noise sensitivity of the focus measurement methods.

### 5.1 Simulated Images

The simulated images were generated by Zemax software using the NPP6-2B optical design. Zemax Development Corporation of Washington State, USA, has developed a popular and widely used range of software for optical system design. Most of the focus measurement tests were performed using simulated images, since the true focal configuration is known for these images.

### 5.2 Real Images

The real images were captured using NPP6-1-0251. The true focus of this device (and other similar devices) cannot be known due to tolerances and imprecision in mechanical assembly, and thus the accuracy of the focus measurement techniques on this data set cannot be assessed.

### 5.3 Differences

There are a number of differences between the simulated and real images.

### 5.3.1 Frequency Content

The frequency content of the simulated images was plotted across the range of focus measurement offsets and compared to the frequency content of the real images across the range of focus measurement offsets. The comparison revealed a low-pass effect present in the real images that is not present in the simulated images. The real images show significant attenuation in frequency component amplitude at high frequencies.

### 6.0 FOCUS MEASURES

A number of different focus measurement methods are possible. To minimize edge and field-of-view effects, all measurements should be made on a central window of the pixels in the image sensor. In the present embodiment, a 128×128 pixel window centred in each image from the image sensor is used for all measurements.

Focus measurement methods can be grouped into three broad categories:
1. Frequency-based methods,
2. Gradient-based methods, and,
3. Statistical methods.

### 6.1 Frequency-Based Methods

Frequency-based focus measurement methods use a transform to extract the frequency content in an image. Since defocus has a low-pass filtering effect (discussed above), the amount of high-frequency content in an image can be used as an estimate of the quality of focus.

The high-frequency content can be measured with the following techniques:

(1) Sum—The energy in the high frequency components is estimated by summing the energy for frequencies above a certain threshold value.

(2) Entropy—Entropy is used to measure the uniformity (i.e., flatness) of a distribution. Images that are well focused will contain more high-frequency content, making the spectrum flatter and thus having a higher entropy measurement.

### 6.1.1 Discrete Fourier Transform

A Fast Fourier Transform (FFT) is the most common discrete Fourier Transform. A FFT of each row and each column in the measurement window is combined to give a 1-dimensional spectrum for the image. The magnitude of the frequency content is then used to estimate the focus.

A potential issue with the use of the FFT is that it assumes that the signal to be transformed is periodic. However, the blocks of data in the image used for the focus measurement are not periodic, which can result in a step in the repeated signal. This discontinuity will have broadband frequency content, resulting in spectral leakage, where signal energy is smeared over a wide frequency range.

To minimize this effect, a window function is typically applied to each block prior to transformation. The effect of the window is to induce side lobes on either side of each frequency component in the signal, resulting in the loss of frequency resolution. However, the effect of the side lobes is typically much less significant than the spectral leakage, so there is usually a benefit in using a window.

### 6.1.2 Discrete Cosine Transform

The discrete cosine transform (DCT) is an alternative to the discrete Fourier transform which offers energy compaction properties, and the boundary conditions implicit in the transform (windowing functions are not usually used with DCT transforms). In the present embodiment, the DCT of each row and each column in the measurement window is combined to produce a single 1-dimensional power spectrum, which is then used to estimate focus using the frequency content measurement methods.

### 6.2 Gradient-Based Methods

Gradient-based techniques use spatial-domain gradient information to estimate the sharpness of an image (i.e. edge detection).

### 6.2.1 Laplacian

The Laplacian operator calculates the second derivatives of the pixel values in the image. This is typically implemented by convolving the image using a Laplacian kernel which acts as a high-pass filter to increase the proportion of higher frequency components in the sensed images. The energy in the filtered image is calculated, where higher energy in the filtered image represents better focus.

### 6.3 Statistical Methods

The pixel-value histogram of an image can be considered a probability distribution, and analysed using statistical measures.

### 6.3.1 Standard Deviation

The standard deviation of the pixel-value distribution can be used to estimate the quality of focus in an image. Well-focused images contain a higher dynamic range and thus have a higher pixel-value standard deviation.

### 7.0 RESULTS

The results of the focus measurements on the simulated and real images and summarized below.

### 7.1 Focus Measurements

All the focus measurement techniques correctly identified the position of best focus. That is, the maxima of the focus curves generated were all at 0 mm offset for the simulated images (which is the known position of best focus for a simulated image). However, the Laplacian produced the sharpest peak, showing that this method is best able to differentiate between well and poorly focused images.

For the frequency methods, the FFT sum-of-high-frequency-energy method performed better than the entropy method, which produced a curve with a very flat peak. The DCT method did not perform well, producing a wide, flat focus curve. The focus curve for the standard deviation method is not smooth, suggesting that this measurement method may not be particularly accurate.

For subsequent tests, the two best performing measurement methods (Laplacian and FFT-sum) were used.

### 7.2 Noise

To test the effects of noise on the focus measurement methods, additive white Gaussian noise was added to the simulated images. The noise had almost no effect on the Laplacian method, while the FFT method is significantly affected. The sharper peak in the FFT curve is indicative of the method misidentifying the additional noise as high-frequency content.

### 7.3 Target Pattern

A comparison of focus measurement results for the simulated images using the random and star patterns showed the star pattern 238 (see FIG. 17) produced a slightly sharper peak using both the Laplacian and the FFT methods. This indicates that it allows a marginally more accurate measurement of focus.

Interestingly, the focus measurement curves for the random pattern 236 (see FIG. 16) do not show an offset or skew due to the changing frequency content. This indicates the random pattern does not suffer from fixed resolution effects.

### 7.4 Accuracy Measurement

All the measurement techniques accurately found the position of optimal focus, with the Laplacian producing the sharpest focus curve. To test the effect of noise, additive white Gaussian noise was added to the images, and the focus measurement repeated. Noise reduces the smoothness of the graphs and introduces errors in the position of optimal focus in both the Laplacian and FFT methods.

### 7.5 Real Images

As discussed above, the true focus for a real image is not known as it is for a simulated image. However, using all the focal measurement techniques discussed above (Laplacian, FFT-sum, FFT-entropy, DCT and Std Dev) the variation in the different points of best focus is relatively small indicating each technique is reasonably accurate.

### 7.6 Curve Fitting

Interpolation can be used to find a precise maximum value for a curve that is represented by a set of sample points. To do this, an interpolating function is fitted to the samples, and the position of the maximum value of the function is found. Typically, a polynomial is used as the interpolating function, and the maximum value is found by finding the roots of the derivative of the polynomial.

When fitting the polynomial to the samples, the degree of the polynomial should accurately represent of the underlying curve. If the degree is too low, the curve will have a high residual error and will not accurately fit the points. However, if the degree is too high, the curve will overfit the points and the resulting maxima is unlikely to be correct. Test results show the maximum focus offset calculated using a number of different polynomials for the FFT-sum curve generated from the real images can vary significantly depending on the degree of polynomial used. Thus, when performing interpolation, the sample points should have as little noise as possible and that an appropriate interpolating function is selected.

### 7.0 CONCLUSIONS

For the simulated images, the Laplacian method is slightly better than the other methods, producing a sharp peak with relatively low noise sensitivity. While the focus measurement methods appear to be quite noise tolerant, noise can reduce the accuracy of the focus position measurement.

The star pattern is slightly better than the random pattern for measuring focus. However, to use this pattern for real focus measurement, the star pattern must be X-Y centred in the focus measurement window. The target must either be accurately positioned with respect to the optics, or that the centre of the star pattern is detected to allow the correct position of the focus measurement window to be found.

The variation in results for the real images can be dealt with by using a number of focus measurement methods, and combining the results to produce a single optimal focus position. This combined method would be less sensitive to errors or biases in any single measurement method.

The invention has been described herein by way of example only. Ordinary workers in this field will recognize many variations and modifications which do not depart from the spirit and scope of the broad inventive concept.

1. A method of positioning an image sensor at a point of best focus for a lens with an optical axis, the method comprising the steps of:
moving the image sensor to a plurality of positions along the optical axis;
using the image sensor to capture an image of a target image at each of the plurality of positions through the lens;
deriving a measure of blur in the image captured at each of the plurality of positions from pixel data output from the image sensor;
deriving a relationship between blur and position of the image sensor along the optical axis;
moving the image sensor to a position on the optical axis that the relationship indicates as the point of best focus; and,
fixedly securing the image sensor relative to the lens.

2. The method according to claim 1 wherein the step of deriving a measure of blur in the image captured by the image sensor at each of the plurality of positions involves deriving the proportion of high frequency content in the target image as a measure of blur.

3. The method according to claim 2 wherein the proportion of high frequency content is estimated by summation of frequency component amplitudes sensed by the image sensor above a frequency threshold.

4. The method according to claim 2 wherein distributions of frequency component amplitudes from the captured images are determined, and the entropy of the distribution is determined and used as a measure the proportion of high frequency content for each of the captured images.

5. The method according to claim 2 wherein the proportion of high frequency content is determined by performing a fast Fourier transform on a selection of pixels from the image sensor and calculating a magnitude of the frequency content of the selection.

6. The method according to claim 5 wherein the selection is a window of pixels from the image sensor, the pixels being in an array of rows and columns, and the fast Fourier transform of each row and column is combined into a 1-dimensional spectrum.

7. The method according to claim 2 wherein the proportion of high frequency content is determined by performing a discrete cosine transform on a selection of pixels from the image sensor and calculating a magnitude of the frequency content of the selection.

8. The method according to claim 1 wherein the step of deriving a measure of blur in the image captured by the image sensor at each of the plurality of positions involves using spatial-domain gradient information from pixels sensed by the image sensor to estimate sharpness of any edges.

9. The method according to claim 8 wherein the spatial-domain gradient information is the second derivative of pixel values from the captured images.

10. The method according to claim 9 wherein the second derivatives are determined by convolving the pixels of the captured images using a Laplacian kernel.

11. The method according to claim 1 wherein the step of deriving a measure of blur in the image captured by the image sensor at each of the plurality of positions involves generating a pixel value distribution by compiling a histogram of pixels values from pixels sensed by the image sensor and calculating the standard deviation of the pixel value distribution such that higher standard deviations indicate better focus.

12. The method according to claim 1 further comprising the step of applying an interpolating function to the measures of blur derived for each of the plurality of positions.

13. The method according to claim 12 wherein the interpolating function is a polynomial and a maximum value of the polynomial is determined by finding the roots of the derivative of the polynomial function.

14. The method according to claim 1 wherein the target image has frequency content that does not vary with scale as the image sensor is moved along the optical axis.

15. The method according to claim 14 wherein the target image is a uniform noise pattern.

16. The method according to claim 15 wherein the uniform noise pattern is a binary white noise pattern.

17. The method according to claim 14 wherein the target image is a pattern of segments radiating from a central point.

18. An apparatus for optical alignment of an image sensor at a position of best focus relative to a lens having an optical axis, the apparatus comprising:
a sensor stage for mounting the image sensor;
an optics stage for mounting the lens;
a target mount for a target image;
a securing device for fixedly securing the lens and the image sensor at the position of best focus; and,
a processor for receiving images captured by the image sensor; wherein,
the sensor stage and the optical stage are configured for displacement relative to each other such that the image sensor is moved to a plurality of positions along the optical axis, the image sensor capturing images of the target through the lens at each of the plurality of positions and the processor is configured to provide a measure of the proportion of high frequency components in the captured images to find the portion of best focus where the measure is a maximum.
